(19) United States
(12) Patent Application Publication
(10) Pub. No.: US 2004/0220886 A1
(43) Pub. Date: Nov. 4, 2004

(54) Communication signal resource chain assignment for optical networks subject to reach constraints

(75) Inventors: Krishnan Kumaran, Scotch Plains, NJ (US); Carl Jeremy Nuzman, Summit, NJ (US); Indra Widjaja, Florham Park, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ

(21) Appl. No.: 10/426,602

(22) Filed: Apr. 30, 2003

(51) Int. Cl. G06F 17/60

(52) U.S. Cl. 705/400; 705/1

(57) ABSTRACT

Techniques and systems for assigning resource chains for transmission of a communication signal from an origination point via a node or a plurality of nodes to a termination point are described. Separate determinations of minimum costs of transmitting the communication signal from the origination point to the node and from the node to the termination point on each of a plurality of channels are made. Potential channels corresponding to such minimum costs are identified. The separate minimum costs are combined and a plurality of cumulative minimum costs of transmitting the communication signal from the origination point to the termination point are determined. A lowest cumulative minimum cost and corresponding selected channels and nodal actions from the origination point to the node and from the node to the termination point are identified. The costs of regeneration and wavelength conversion resources consistent with the channels may also be identified. Decentralized determination and ranking of resource chain assignment options is facilitated while improved system performance, reduced computations, and better resource utilization are achieved.

### FIELD OF THE INVENTION

The present invention relates to methods and systems for operating wavelength division multiplexed optical telecommunication networks that enable selected assignment of transmission, switching, and regeneration resources in segments of the network route from the signal origination point to the termination point. The methods and systems according to the present invention enable decentralized determination and ranking of resource chain assignment options. These methods and systems achieve improved performance, reduced computations, and better resource utilization compared, for example, with methods and systems that cannot take reach restraints into account.

### BACKGROUND OF THE INVENTION

Wavelength division multiplexing enables a large number of communication signals to be simultaneously carried by a single optical fiber. In a telecommunications network having sufficiently numerous optical fibers linking nodes on a route between a signal origination point and termination point and sufficiently low impairments to transmission, it is theoretically possible for a signal at a given wavelength to be transmitted through its entire route without any wavelength conversion or regeneration. Such a network route is said to be fully transparent. Given an exemplary signal that must traverse a number of nodes in order to reach its termination point, however, existence of such a transmission route generally is not always possible due to the unavailability of a specific wavelength or accumulation of transmission impairments.

Reservation of dedicated routes in all cases for each signal at a selected wavelength from the origination point to the termination point would result in grossly inefficient use of the communication signal carrying capacity of the optical fiber network. Hence, it is generally necessary to enable switching of a given signal from one optical fiber to another, as well as conversion of the signal wavelength and signal regeneration at network nodes. For example, links between pairs of nodes can be provisioned with a plurality of optical fibers, so that a signal originating at a given wavelength can be switched enroute from optical fiber to optical fiber to its termination point in this manner the signal can continue to be transmitted at a given wavelength notwithstanding that other signals may be using the same wavelength on various links along the route. Alternatively or in addition, a node can be provisioned with a wavelength converter so that a given signal using one wavelength on an input optical fiber can be switched onto a different wavelength on an output optical fiber. Optical signals require periodic regeneration as a result of physical impairments such as dispersion, attenuation and noise. Wavelength conversion can be done simultaneously with regeneration at little additional resource cost. Hence, a point of required regeneration of a signal is also an opportunity to change its wavelength.

In current wavelength division multiplexed (WDM) optical networks, the transmission system for each link is essentially independent of other links, with links connected at network nodes via 3R regeneration, that is, retiming, reshaping and reamplification. Maximum use of all wavelengths on all optical fibers on a link between two nodes can, in this manner, be ensured by such regeneration of all signals arriving at the source node for a given link. A network operating in this manner is referred to as being opaque. The network has unlimited flexibility to use every wavelength on every optical fiber on the link, and every transmission decision can be made locally at the transmitting node on a link, independent of activity on any other portion of the network. However, this opaque mode requires provision of adequate regenerator capacity at every node to regenerate every signal. Furthermore, this opaque mode requires local computational control over and execution of a maximum volume of signal switching and wavelength conversion. High levels of hardware provisioning are required, and high operational costs result.

A network link consists of transmission equipment for carrying optical communication signals across some distance, from an origination point to a termination point. A node is a point at which multiple links terminate or originate. Each link consists of one or more optical fibers, and each optical fiber may concurrently carry optical signals on one or more independent wavelengths, which are referred to as channels. At a node, optical signals arriving on terminating input links may be connected onto originating output links, or they may be dropped from the network onto a local receiver. Signals that are not dropped are called pass through signals. Pass through signals must undergo wavelength conversion if the channels used on the input and output links use different wavelengths. Pass through signals may also be regenerated, meaning that the signal quality is restored to its original level. A device that regenerates and provides wavelength conversion for a signal is called a regenerator. A device that provides wavelength conversion without regeneration is called a wavelength converter. A network route includes a connected sequence of nodes and links through the optical network from a source node to a destination node. A resource chain is a sequence of channels and node actions specifying in detail how an optical signal traverses a network route. The node actions may include wavelength conversion and regeneration.

Recent advances such as ultra long reach systems and optical cross connects promise to substantially reduce the need for regeneration done solely to neutralize physical impairments within the network. Hence, realization of the cost savings promised by such developments will require reduced dependence on the use of regenerators as wavelength converters when regeneration is unnecessary. Dynamic operation of networks with optimized use of the available channels will also be necessitated by the availability of increasingly sophisticated network services. These services are driven by new applications such as efficient transfer of high speed block storage traffic across a wide area network, virtual private networking, and Internet protocol networking. For example, services that have been identified by the Internet engineering task force (IETF) include bandwidth on demand service, and optical virtual private network service. These new services require optical networks that can set up and tear down resource chains in a dynamic fashion.

To address the signaling requirement, the IETF has defined a new optical signaling framework called generalized multiprotocol label switching (GMPLS), which is based on extending the packet oriented nature of multiprotocol label switching to a generalized data plane. In the GMPLS framework, routing and resource chain assignment are separated in order to avoid the need for a centralized controller or flooding of excessive network state information. Limited network state information, including the available capacity on each link, is instead distributed to all network nodes. For a new demand, the source node uses this distributed information to determine an appropriate route. A signaling protocol such as resource reservation protocol with traffic engineering (RSVP-TE), designed for use on connection oriented networks, is used to send a resource reservation message along the route to the termination point, and to return an acknowledgement from the termination point. A resource chain is reserved for the communication signal during this reservation stage, because detailed channel availability information is known only at nodes adjacent to a given link, and the available node actions are known only at a given node.

Given the impracticality of fully transparent and fully opaque operating systems, much work has been done to design partially transparent networks. In a partially transparent network, signals are regenerated if and where necessary due to physical impairments and preoccupied channels. An ideal partially transparent network would always know where and in what manner a given signal should optimally be converted from one wavelength to another or regenerated. One or more of these steps might be needed at several or many points in the course of transmission of a long distance signal. Systems have been designed that take into account the availability of wavelength conversion capacity at a given node and thus attempt to reassign a given signal to an available channel for its next link. However, such systems do not take reach constrains into account. Here, a given signal may arrive at a node where it needs to be regenerated or converted to a channel at a different wavelength in order to proceed but where there is no currently available regenerator capacity, causing signal delay or failure. Furthermore, with such systems it is not possible to take advantage of signal regeneration requirements to simultaneously execute wavelength conversions at little or no additional network resource costs.

Any solution to the resource chain assignment problem must also be compatible with prevailing network architectures. For example, the GMPLS standard requires signal routing and resource chain assignment to be separated in order to eliminate the need for a centralized network traffic controller. In order to be compatible with such standards, systems and methods for assigning resources to a given signal must further be able to handle computation of the resource chain on a distributed basis.

There accordingly is a need for methods and systems for assigning available channels and regenerators to a given communication signal enroute between its designated origination point and termination point, operating on a computationally distributed basis that minimizes the data to be collected, processed and communicated. Such methods and systems should take into account the dynamic availability of channels on multiple optical fibers between each pair of nodes, the availability of the same wavelength on multiple optical fibers, and the availability of regenerator and wavelength converter capacity at each node. Such methods and systems should also take into account the need for the communication signal to be regenerated at particular points enroute, and the desirability of minimizing regeneration and wavelength conversion operations on a given signal.

### SUMMARY OF THE INVENTION

In one embodiment according to the present invention, a method is provided for assigning a resource chain for transmission of a communication signal from an origination point to a termination point, comprising the steps of (a) defining an origination point, a node and a termination point, interconnected by optical fiber channels each constituted by a defined wavelength on an optical fiber, collectively constituting a route to be evaluated for transmission of a communication signal from said origination point to said termination point; (b) determining first minimum costs of transmitting said communication signal from said origination point to said node by using a plurality of first channels, and identifying potential first channels corresponding to said first minimum costs; (c) determining second minimum costs of transmitting said communication signal from said node to said termination point by using a plurality of second channels, and identifying potential second channels corresponding to said second minimum costs; (d) combining said first and second minimum costs and determining a plurality of cumulative minimum costs of transmitting said communication signal from said origination point to said termination point on a plurality of channels, and identifying a lowest cumulative minimum cost and corresponding selected first and second channels; and (e) transmitting said communication signal from said origination point to said termination point on said selected first and second channels.

In a further embodiment according to the present invention, such a method is provided for assigning a resource chain for transmission of a communication signal from an origination point to a termination point in which an origination point, a first node, a second node, and a termination point are defined, and minimum costs are respectively determined for transmitting said communication signal from said origination point to said first node, from said first node to said second node, and from said second node to said termination point. In another embodiment according to the present invention, such a method is provided in which a reservation signal is provided to store and transmit said first minimum costs. In yet a further embodiment according to the present invention, such a method is provided in which said first and second minimum cost are determined by taking into account needs for regeneration of said communication signal. In still other embodiments according to the present invention, such methods are provided that take into account one or more of the following: (1) a preference for avoiding regeneration of said communication signal; (2) the availability of capacity for signal regeneration at said origination point and said node; (3) the availability of capacity for signal wavelength conversion at said origination point and said node; (4) the availability of each of said plurality of first and second wavelengths on a plurality of optical fibers; (5) the total availability of channels at said origination point and node; and (6) a preference for avoiding signal wavelength conversion.

In another embodiment according to the present invention, an optical communications network is provided comprising an origination point, a node and a termination point, interconnected by optical fiber channels each constituted by a defined wavelength on an optical fiber, and including a signal regenerator having a defined capacity adapted to regenerate signals passing through said node, in which a resource chain for transmission of a communication signal from said origination point to said termination point is determined by a method comprising the following steps: (a) determining first minimum costs of transmitting said communication signal from said origination point to said node by using a plurality of first channels, and identifying potential first channels corresponding to said first minimum costs; (b) determining second minimum costs of transmitting said communication signal from said node to said termination point by using a plurality of second channels, and identifying potential second channels corresponding to said second minimum costs; (c) combining said first and second minimum costs and determining a plurality of cumulative minimum costs of transmitting said communication signal from said origination point to said termination point on a plurality of channels, and identifying a lowest cumulative minimum cost and corresponding selected first and second channels; and (d) directing said origination point to transmit said communication signal to said termination point on said selected first and second channels.

A more complete understanding of the present invention, as well as other features and advantages of the present invention, will be apparent from the following detailed description and the accompanying drawings.

### BRIEF DESCRIPTION OF THE DRAWINGS

FIG. 1 shows an exemplary method according to the present invention for assigning a resource chain for transmission of a communication signal from an origination point to a termination point;

FIGS. 2 and 3 show a route for an exemplary communication signal, and a trellis representation of resource chain assignment with reach constraints for the route, respectively;

FIGS. 4 and 5 show a route for an exemplary communication signal providing for two classes of optical fiber on one exemplary link, and a trellis representation of resource chain assignment with reach constraints for the route, respectively;

FIG. 6 shows an exemplary optical network for implementation of methods and systems according to the present invention;

FIG. 7 shows an exemplary optical network node on the network in FIG. 6;

FIG. 8 shows an exemplary embodiment of share per node physical layer communication hardware useful in the node shown in FIG. 7;

FIGS. 9 and 10 show a route for an exemplary communication signal, and a corresponding trellis representation of resource chain assignment including mathematical notations, respectively;

FIGS. 11 and 12 show blocking probability versus offered load for ring and mesh networks with no reach constraints, respectively;

FIGS. 13 and 14 show blocking probability versus offered load for ring and mesh networks with maximum reach of two links, respectively;

FIGS. 15 and 16 show capacity improvements in the methods and systems according to the present invention as compared with resource chain determination by a conventional greedy algorithm for ring and mesh networks with reach constraints, respectively;

FIG. 17 shows blocking probability versus number of regenerators per node for a mesh network with no reach constraints and with a fixed offered load;

FIGS. 18 and 19 show the minimum number of regenerators needed to give the network 90% of the capacity of an opaque network for ring and mesh networks, respectively; and

FIG. 20 shows blocking probability versus offered load, for a mesh network with tunable transmitters.

### DETAILED DESCRIPTION

The present invention provides methods and systems for assigning resource chains for transmission of a communication signal from an origination point to a termination point. The methods and systems according to the present invention determine the availability of channels and resources to execute node actions along a designated route for the communication signal and then assign an optimized resource chain for transmission including designated points of specified channel changes, wavelength conversion and signal regeneration.

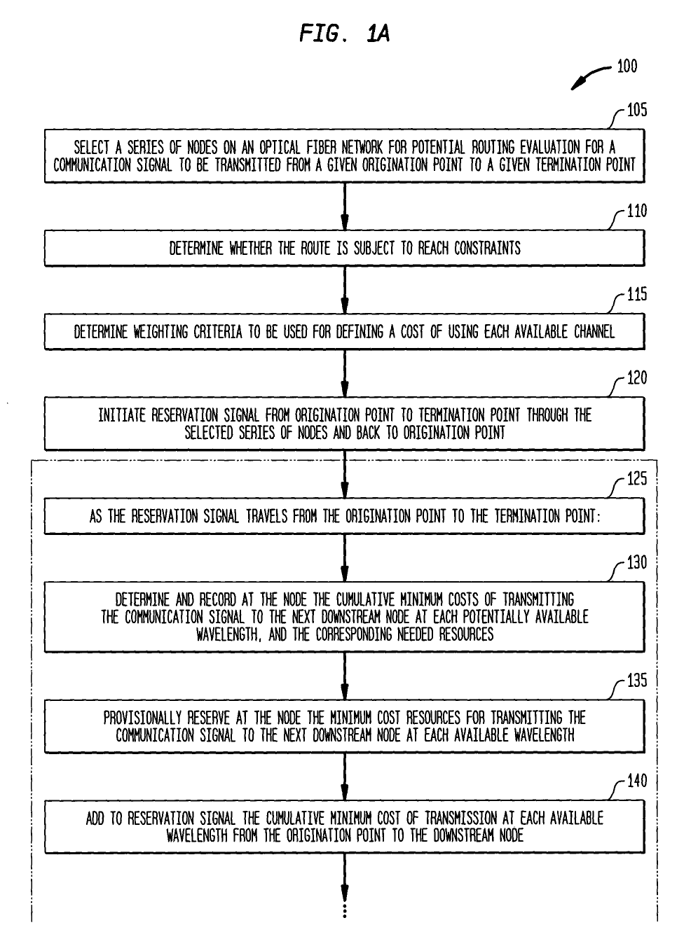

FIG. 1 is a flow chart of an exemplary method 100 in accordance with the present invention. As an initial overview of FIG. 1, the method 100 begins at step 105 with selection of a series of nodes and links defining a potential route through which a communication signal will be transmitted from its origination point to its intended termination point. This exemplary embodiment employs a preferred mode in which at step 120 a reservation signal is provided at the origination point, is sent to the termination point, and then is returned to the origination point. As the reservation signal travels from the origination point to the termination point, the steps collectively indicated at 125 are prompted and executed, enabling analysis of all possible channels and regeneration points for the communication signal, and determination of a resource chain which is optimal in order to minimize the costs of transmitting the communication signal from the origination point to the termination point. As the reservation signal travels from the termination point back to the origination point, the steps collectively indicated at 165 are executed, enabling final reservation of the optimal resource chain for transmission of the communication signal. This reservation process requires a round trip propagation delay plus a small amount of processing time. Following completion of the foregoing steps, the communication signal is transmitted at step 180 using the optimal resource chain from the origination point to the termination point.

Referring again to step 105, a node or series of nodes on an optical fiber network is selected for evaluation as defining a potential route through interposed optical fibers for a communication signal to be transmitted from a given origination point to a given termination point. A node is any point at which the signal may change its route on a multidirectional optical fiber network, may be regenerated, may be converted from one wavelength to another, or otherwise manipulated. It is to be understood that series of nodes including any number of nodes are contemplated. As the complexity of a series or cross connected mesh of nodes increases, the need for and utility of the exemplary method embodied in FIG. 1 increases accordingly.

It is further to be understood that although the present invention relates to the assignment of optical resource chains for transmission of a communication signal on optical links, the methods and systems according to the present invention may also incorporate the use of non-optical links and nodes. For example, regenerators may convert an optical signal to an electrical signal, operate on that electrical signal, and then convert the electrical signal back to an optical signal. Electrical signal links, furthermore, may be interposed between optical fiber links on a signal route in a network or may be present at the signal origination point or termination point. Full regeneration, also known as 3R regeneration, includes retiming, reshaping and reamplification of an optical signal. It is to be understood that the methods and systems according to the present invention can be implemented with complete or partial regeneration as desired in any given instance.

In one embodiment according to the present invention, the method of FIG. 1 is executed only for one potential route for a given communication signal over a selected series of nodes. Such a potential route may be selected, for example, using predetermined criteria based on the relative locations and overall capacities of all of the nodes and interposed optical fiber links on the network, and on the practical desirability of delivering the communication signal to its termination point by a direct route using minimal network resources. In another embodiment according to the present invention, current network audit information may be received before a potential route is selected for evaluation according to the method of FIG. 1, and such current network audit information can be used to aid in selecting a potential route for evaluation.

At step 110 shown in FIG. 1, a determination may be made as to whether or not the route proposed for evaluation is subject to reach constraints. Reach constraints are those factors that impede direct transmission of a communication signal from an origination point to a termination point, and which may be overcome by regeneration of the communication signal enroute to the termination point. Regeneration can be required by a variety of physical impairments, such as signal attenuation, signal dispersion, or noise. In the absence of reach constraints, regenerators are only needed to provide wavelength conversion. In this special case, the computational complexity of the method embodied in FIG. 1 is reduced. The resource chain in this case is simply referred to as a wavelength assignment. Advantageously, application of the method embodied in FIG. 1 is omitted in this special case. For example, in such a case, current network audit information may be received at the origination point, evaluated, and a direct route chosen for the signal. Alternatively, step 110 may itself be omitted, and the method of FIG. 1 can be applied to all communication signals on the network or on a portion of the network. The method of FIG. 1 preferably is applied to select an optimum resource chain for any communication signal to be transmitted through at least one node; but the method can also be applied regarding communication signals to be transmitted directly from an origination point to a termination point without passing through any node.

At step 115, weighting criteria are determined for use in resource chain assignment by defining costs of usage of channels and node actions. The purpose for assigning costs to usage of each channel and to execution of node actions in accordance with the present invention is to facilitate efficient use of network transmission resources. Given a communication signal to be transmitted over several optical fiber links interposed between several nodes, a fundamental issue in resource chain assignment is the selection of the optimum channel for carrying the communication signal on each such optical fiber link. A given optical fiber link may contain a plurality of optical fibers. Each optical fiber may have the capability to simultaneously carry signals at a plurality of different discrete wavelengths. Hence, each possible wavelength on each optical fiber on a link between two nodes constitutes a channel. For example, an optimum resource chain for transmission of a communication signal from a first node via a second node to a third node may require use of a first wavelength on a first optical fiber for the link between the first and second nodes; and a second wavelength on a second optical fiber for the link between the second and third nodes. A related fundamental issue in resource chain assignment is the need for signal regeneration due, for example, to physical impairments. Moreover, regenerators typically are capable of wavelength conversion, so that there is a synergistic value in planning signal regeneration to be compatible with optimized wavelength conversions. Another related fundamental issue in resource chain assignment is the efficient use of available network resources and the avoidance of capital costs for added hardware. Hence, although the resource chain assignment issue could be solved by simply providing massive signal regeneration and wavelength conversion capacity at every node in a network, that is not cost effective or practical.

Referring again to step 115 of FIG. 1, weighting criteria are selected for placing costs on all available channels on each link and all available node actions at each node on the proposed network route between the origination point and termination point for a given communication signal. The resulting costs are reflective of the cost and desirability of use of a given resource, and of the impact of use of such resource on the quality and quantity of resources then remaining available for use by other communication signals on the network. The potential resource chain having the lowest cumulative cost will be selected and used to transmit the communication signal.

A variety of weighting criteria can be designed and selected to suit network needs. Several potential weighting criteria, which can be used alone or in combination, are provided below. However, other criteria best suited to a particular network, class of customers, equipment configuration, regulatory structure, type of communication signal, or other network considerations can be used.

For example, the cost of the use of a given channel on a link can be made inversely proportional to the total number of channels that are currently available on the link. Such total number is the sum of all channels that the signal processing equipment at the originating end of the link is capable of sending and that the signal processing equipment at the receiving end of the link is capable of receiving on all optical fibers present on the link, less the sum of all included channels that are currently in use or out of service. As the total number of such available channels on the link decreases, the cost of use of each such channel increases. For example, the cost to the overall network of using the last available channel on the link may be very high. If no channels are currently available on a link, then the cost of use of such a nonexistent channel can be designated as a predetermined large number, or infinity. As a further variation, the costs of use of various links can be relatively weighted. For example, if a particular link can be easily bypassed by an alternative link, the costs of use of channels on both such links can be made interdependent. Such a variation would be useful when the methods and systems according to the present invention are used to determine optimal resource chains for two or more different routes, and when the resulting resource chains for the different routes are to be compared.

In another embodiment according to the present invention, the cost of use of a given channel on a link can be made inversely proportional to the total number of channels at the same wavelength that are currently available on a plurality of optical fibers on the link. Such a valuation emphasizes the overall availability of a given wavelength to carry a communication signal on the link, taking into account the capability of any of a plurality of optical fibers that may be in operation on such link to carry a communication signal at such wavelength. Hence, the scarcity of a particular wavelength at a given time on the subject link can be taken into account in the valuation of all alternative channels over the link. In a variation of this embodiment, the total number of different wavelengths that are currently available to be transmitted and received over the link can be considered. For example, placing in use the last channel at a certain wavelength on a link having a small number of available wavelengths is a greater burden to the network, and accordingly merits a greater assigned cost, than placing in use the last channel at a certain wavelength on a link having a tremendous number of other available wavelengths.

In a further embodiment according to the present invention, the cost of use of a given channel on a link can be made inversely proportional to the total regenerator capacity available to the originating node. Regenerators are required in order to counteract physical impairments of a communication signal due to, for example, attenuation, dispersion and noise. In general, the need for regeneration of a communication signal increases with increasing distance between the signal origination point and termination point. When the communication signal reaches a point of maximum tolerable physical impairment, regeneration may be mandatory in order to avoid irreversible degradation or loss of the communication. Hence, providing regeneration at such points can be essential to permit reception of a communication signal. Exhaustion of regenerator capacity at any node in the network accordingly is to be avoided. In addition, regenerators typically can convert a communication signal to a desired different wavelength. Wavelength converters not capable of signal regeneration may also be provided. Ensuring the adequate availability of these system hardware components for use online in the network where they are needed is thus important. Accordingly, weighting criteria can be established that take into account remaining regenerator and wavelength converter capacity not already in use or reserved for future use at a given node. In a variation of this exemplary embodiment, the weighting criteria can provide for tolerance of a maximum proportion of signal failures due to the localized absence of such capacity. For example, where routing through an alternative series of nodes is available, the temporary elimination of regenerator or wavelength converter capacity at a given node may be tolerable.

In an additional embodiment according to the present invention, weighting criteria may be established that minimize the selection of a channel for a communication signal that requires wavelength conversions, or that create a preference for wavelength conversions that are carried out at points when regeneration of the signal is also required. Conversion of the wavelength of a communication signal at the point where the signal also requires regeneration due to physical impairments is an efficient event for the network. Conversion of the wavelength of a communication signal solely for purposes of rerouting the communication signal incurs a cost equal to the value of the loss of availability of the regenerator channel used to carry out the conversion. However, such wavelength conversion adds value by providing an available channel for the communication signal to proceed toward its termination point. Furthermore, depending upon the availability of regenerator capacity for a communication signal downstream of a subject link, it may be preferable or even essential to regenerate a given communication signal before further transmission of the communication signal is foreclosed by reach constraints. In a variation of this exemplary embodiment according to the present invention, the weighting criteria may take into account a fixed maximum distance that may be traversed by a communication signal through any portion of the network before its regeneration is required.

In one preferred embodiment according to the present invention, weighting criteria are predetermined for the overall network. In this manner, weighting criteria are standardized across the network, which prevents conflicts, eliminates the need to execute step 115 in assigning the resource chain for a given communication signal, and may simplify computations. In another exemplary embodiment, weighting criteria are predetermined for a region or a subsystem within the network. In an additional embodiment according to the present invention, the performance of the network can be centrally monitored, the weighting criteria can be continuously adjusted, and the currently applicable weighting criteria can be distributed to nodes across the network. In yet a further embodiment, weighting criteria may be determined for a given communication signal after selection of a proposed route at step 105, and then used solely for assigning a resource chain for such communication signal.

Once the weighting criteria are determined for use in defining costs of usage of channels at step 115, then at step 120 a reservation signal is initiated at the signal source node, sent to the destination node, and then returned to the source node. The source node is that node, in the series of nodes defining the proposed route for the communication signal, that is closest to the signal origination point; and the destination node is that node in the series that is closest to the signal termination point. The reservation signal carries instructions as to its own route on the network. The primary purposes of this reservation signal are to: communicate to the nodes along the proposed signal route the need to establish a resource chain for the communication signal, collect and distribute data used in determining and provisioning such a resource chain, and confirm such arrangements to the signal origination point so that the communication signal is then transmitted to its termination point.

If the signal origination point itself constitutes a node, then the reservation signal can be originated there. If the signal origination point is not a node but is instead, for example, a transmitter operated by a customer of the network, then preferably the reservation signal is originated by a node in the series constituting the proposed route for the communication signal. In such a case, preferably such node or some other control element on the network instructs the signal origination point as to when and how to initiate transmission of the communication signal. In one embodiment, the source node originates the reservation signal. In another embodiment, one of the other nodes in the series originates the reservation signal. In an additional embodiment, one reservation signal is transmitted from the source node to the destination node, and another reservation signal is transmitted from the destination node to the source node. In yet a further embodiment, the reservation signal can be originated at some other point in the network, such as, for example, a central or regional network control station. In a variation of such further embodiment, nodes on the network can send reservation signals to such other point in the network for analysis, determination and provisioning of a resource chain for the communication signal, and transmission of such communication signal on the resource chain.

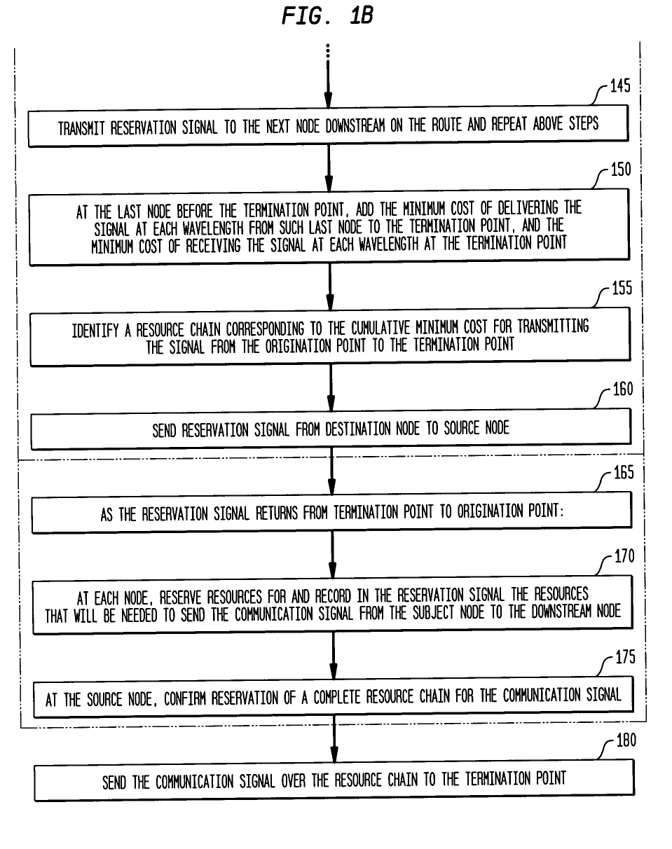

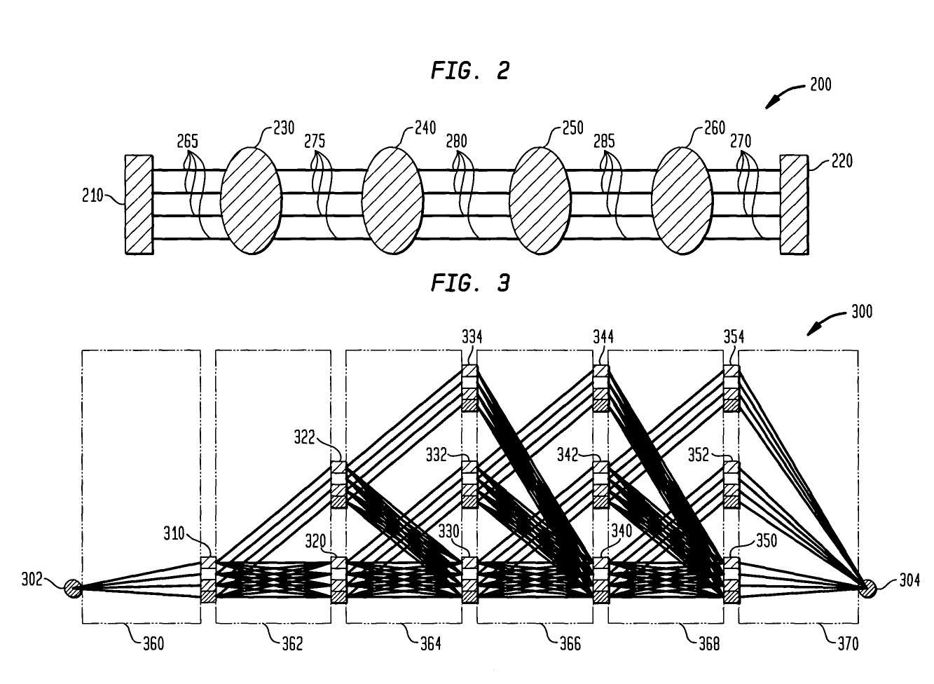

An exemplary embodiment in which the reservation signal is originated by the source node is now further discussed in connection with FIGS. 1, 2 and 3. It will be understood that other embodiments such as those discussed above may also be used. FIG. 2 illustrates a route 200 that includes a transmitter 210, a receiver 220, a source node 230, two intermediate nodes 240 and 250, and a destination node 260. FIG. 2 further illustrates a set of four channels on link 265 linking transmitter 210 and source node 230, representing four possible wavelengths that may be produced by the transmitter 210. FIG. 2 additionally illustrates four channels forming links 275, 280, 285, and 270 respectively between source node 230 and intermediate node 240; between intermediate nodes 240 and 250, between intermediate node 250 and destination node 260; and between destination node 260 and receiver 220.

FIG. 3 shows a trellis 300 illustrating an exemplary method according to the present invention that can be used to find the least cost resource chain among the set of all possible resource chains on route 200 of FIG. 2. This exemplary method assumes that each optical fiber link operates at the same four defined wavelengths. This exemplary method also assumes that a signal requires regeneration after traversing three links on the route. The points 302 and 304 represent cumulative communication signal transmission costs accrued at the transmitter 210 and the receiver 220, respectively. Data array 310 has four values representing costs of traversing channels on link 265 from transmitter 210 to the input to source node 230 and arriving on each of the four possible wavelengths, respectively. Data arrays 320 and 322 represent cumulative costs of traversing links 265 and 275 from transmitter 210 to the input to intermediate node 240. Data arrays 330, 332 and 334 represent communicative costs of traversing links 265, 275 and 280 from transmitter 210 to the input to intermediate node 250. Data arrays 340, 342 and 344 represent cumulative costs of traversing links 265, 275, 280 and 285 from transmitter 210 to the input to destination node 260. Data arrays 350, 352 and 354 represent cumulative costs of traversing links 265, 275, 280, 285 and 270 from transmitter 210 to the input to receiver 220, and including the costs of being received by receiver 220. The costs of such reception may include, for example, considerations of the channel and wavelength capacities of the receiving equipment at the termination point. Dotted lines define boxes 360, 362, 364, 366, 368 and 370. The solid lines within such boxes indicate possible node actions that may occur at the transmitter 210, source node 230, intermediate node 240, intermediate node 250, destination node 260, and receiver 220, respectively.

Every resource chain that could be used to traverse the route 200 of FIG. 2 is represented by a path through the trellis of FIG. 3. Likewise, every path through FIG. 3 corresponds to a resource chain for FIG. 2. The problem of finding a least cost resource chain for use in transmitting a communication signal over the route 200 in FIG. 2 is solved by finding a least cost path through the trellis of FIG. 3. Representing all of the possible resource chains in this way enables the methods and systems according to the present invention to take advantage of established methods for efficiently finding least cost paths through trellises. As the discussion below will show, the computations necessary to find a least cost path through the trellis of FIG. 3 can be performed efficiently even though the number of possible resource chains is very large.

In one type of potential resource chains, communication signals are regenerated at all of the nodes 230, 240, 250 and 260 of the route 200. Since the exemplary network represented in FIGS. 2 and 3 operates on four defined wavelengths, transmitter 210 can potentially generate communication signal at four different wavelengths represented by channels on like 265. These four choices, constituting node actions, are illustrated by the four lines in box 360. The four elements of data array 310 represent the channels of different wavelengths on link 265.

Before transmission from source node 230, a communication signal on any of the four channels on link 265 can be regenerated, converted to one of the other three wavelengths and then transmitted on channels over link 275 to intermediate node 240. It is further possible that a communication signal may be regenerated at node 230 and then transmitted to intermediate node 240 at the same wavelength. Hence, the capacity for regeneration of all four channels at source node 230 is represented by the lines that connect data arrays 310 and 320. Each of the four channels represented by data array 310 is connected to all four channels represented by data array 320. Similarly, the lines that connect data arrays 320 and 330, data arrays 330 and 340, and data arrays 340 and 350 respectively represent regeneration of all four channels at intermediate node 240, intermediate node 250, and destination node 260. Such representations of regeneration of all four channels correspond to an operating mode in which every communication signal arriving at a node on any of the four possible channels on any optical fiber is regenerated and thus can be further transmitted on any available channel at any of the four desired wavelengths on any optical fiber.

A communication signal can be carried at any of the four wavelengths on channels over link 265 from the transmitter 210 to source node 230, and at any of the four wavelengths on channels over link 275 from source node 230 to intermediate node 240. Accordingly, there are 4×4=16 possible partial resource chains for arrival of a communication signal at the input to intermediate node 240 assuming regeneration of all signals at source node 230. These partial resource chains are represented by the 16 paths in the trellis of FIG. 3 that lead from point 302 through data array 310 to data array 320.

In a similar manner, there are 4×4×4=64 separate possible partial resource chains resulting in arrival of a communication signal regenerated by nodes 230 and 240 at the input to intermediate node 250 on each of the four possible wavelengths, represented by the 64 possible paths from point 302 through data arrays 310 and 320 to data array 330. Similarly there are 4×4×4×4=256 separate possible partial resource chains resulting in arrival of a communication signal regenerated by nodes 230, 240, and 250 at the input to destination node 260 on each of the four possible wavelengths, such partial resource chains being represented by the 256 possible paths from point 302 through data arrays 310, 320, and 330, to data array 340. Finally, there are a total of 4×4×4×4×4=1,024 possible complete resource chains that use regeneration at each of the nodes 230, 240, 250, and 260. These resource chains are represented by the 1,024 paths from point 302 to point 304, passing through data arrays 310, 320, 330, 340, and 350.

The data arrays 322, 332, 334, 342, 344, 352, and 354 are required to be included in the trellis in order to represent the resource chains that do not use regeneration at every node. FIG. 3 assumes that a given communication signal may be transmitted over three links without regeneration, but that regeneration is then mandatory. It is to be understood, however, that this is an arbitrary simplification. Other standardized regeneration limits may be present in a network, or in subportions of a network. Alternatively, regeneration limits may be monitored across the network, or determined in the course of establishing a resource chain for each communication signal.

Referring again to FIG. 3, the four lines between data arrays 310 and 322 represent the node action of permitting the communication signal to pass through node 230 without regeneration. In this case, no wavelength conversion occurs at node 230, and hence the lines only connect the matched pairs of elements of data arrays 310 and 322 that represent the same wavelength. There are 4 paths from point 302 to data array 310 to data array 322, representing the four possible partial resource chains that traverse links 265 and 275 and do not use regeneration at node 230. The four lines between data arrays 320 and 332, and the four lines between data arrays 322 and 334 likewise represent transmission of a communication signal on each of the four wavelengths through intermediate node 240 to intermediate node 250 on channels over link 280 without regeneration at node 240. The paths that proceed from point 302 through data arrays 310, 320, and 332 represent all of the partial resource chains that are regenerated at node 230 and not regenerated at node 240. The paths that proceed from point 302 through data arrays 310, 322, and 334 represent all of the partial resource chains that are not regenerated at node 230 or 240. A communication signal using such a resource chain will have traversed three links, including links 265, 275 and 280, and then must be regenerated at node 250. For this reason, there are no lines connecting data array 334 to a hypothetical data array 346, not shown, arranged above data array 344 in the trellis. Instead, there are only lines connecting data array 334 to data array 340, representing regeneration occurring at node 250. Similarly, lines connecting data array 344 to data array 350 represent required regeneration at node 260 due to reach constraints.

The data array 322 is connected both to data array 334 and to data array 330. The lines connecting data array 322 to data array 330 represent the action of regeneration at node 240. Paths that traverse data arrays 310, 322, and 330 in series thus represent partial resource chains that do not use regeneration at node 230 but that do use regeneration at node 240. This regeneration is early in the sense that it is not required by physical impairments until node 250. Such early regeneration of a communication signal at intermediate node 240 may be required in order to perform wavelength conversion, or may be desirable due to regeneration capacity constraints at intermediate node 250 or at destination node 260. Such regeneration capacity constraints may impact either the capability of regenerating the communication signal, or may prevent wavelength conversion of the communication signal as needed due to channel availability constraints. There are 4×1×4=16 possible partial resource chains that do not regenerate at node 230, but that do use regeneration at node 240. These partial resource chains are represented by the paths through data arrays 310 and 322 in series to data array 330, and are in addition to the 64 paths through data arrays 310 and 320 to data array 330 previously discussed. Considering both the resource chains that do not use regeneration at every node, plus the resource chains that do use regeneration at every node, there are 64+16=80 paths from point 302 to data array 330, corresponding to all of the possible partial resource chains for transmission of a communication signal from transmitter 210 to the input of node 250 that use regeneration at node 240. The merger of the lines from data array 320 with lines from data array 322 at data array 330 represents the fact that regeneration restores signal quality to its original level.

The remaining data arrays 332, 334, 342, 344, 352 and 354 have analogous meanings, and the remaining sets of lines interconnecting such data arrays with the others already discussed constitute representations of analogous resource chains through the route 200 from transmitter 210 to receiver 220. For example, the set of all paths passing through data array 354 represents the set of all resource chains that use regeneration at intermediate node 240, then pass through intermediate node 250 and destination node 260 without regeneration or wavelength conversion, and are received by receiver 220.

Paths leading from point 302 to data arrays 330, 332 and 334 collectively represent the partial resource chains corresponding to use of all of the different channels from transmitter 210 to the input to intermediate node 250, including regeneration options. There are 80 paths leading to data array 330, 4×4×1=16 paths leading to data array 332, and 4×1=4 paths leaning to data array 334 for a combined total of 100 paths. By continuing with these calculations, it can be determined that there are in total 2,464 possible resource chains for the route of FIG. 2, each of which is represented by a path through the trellis of FIG. 3. When the number of wavelengths in the system is increased beyond the four wavelengths considered in this simple example, the total amount of data and computations that are needed to enumerate all possible resource chains quickly become enormous.

In one embodiment according to the present invention, the enormity of such data and options are simplified by retaining complete raw calculated trellis data only so long as they are needed for computational purposes in order to efficiently find least cost paths through the trellis of FIG. 3. Such least cost paths can accordingly be found by separately handling the two related processes of (1) calculating the cumulative costs of use of the least cost channels and least cost node actions, and (2) identifying the corresponding resource chains. Each element of each data array of FIG. 3 is eventually populated with the minimum cost among all partial resource chains that originate at point 302 and terminate at the given data array element. Referring first to data array 310, only one data point is calculated for each of the four channels over link 265, because transmitter 210 simply transmits the communication signal on one of the four channels. In contrast, data array 320 represents the regeneration of the communication signal at node 230 and then transmission on any desired channel over link 275. Since a communication signal arriving at node 230 can thus be switched to any of the four channels, there are 4×4 data calculated in generating data array 320. However, since only the least cost datum for each element in the data array is relevant, the other data can immediately be discarded once the least cost datum is identified. Hence, data array 320 is populated with only 4 data, one in each array element, representing the minimum cumulative cost among the costs of the four paths from point 302 through data array 310 to that element of data array 320. An identification is also stored as to which of the four elements of data array 310 was traversed in the minimum cost path to the specified element of data array 320. Data array 322 can be generated in the same manner, and populated in the same manner with only 4 data, one in each element.

Referring now to intermediate node 240, this node is responsible for transmitting the communication signal to intermediate node 250. If all of the preceding raw array data were stored and transmitted to intermediate node 240, a total of 80 cumulative costs representing different paths from point 302 to 330 could be computed in order to populate the four elements of data array 330 corresponding to each of the four network operating wavelengths. However, since only 4 data are stored in each of data arrays 320 and 322, only 4×4×2=32 cumulative cost data are calculated and evaluated in generating data array 330. Intermediate node 240 can then compile the lowest cumulative cost at each of the four wavelengths, and populate data array 330 with only four data, that is, the minimum cumulative costs for each of the four elements in the data array. The least cost path leading to a given element of data array 330 must pass through an element of either data array 320 or data array 322. The identity of this element is stored, to be used later in generation of the complete resource chain to be used in transmission of the communication signal. Intermediate node 240 can carry out analogous processing of data arrays 332 and 334.

The minimum cumulative costs in data arrays 330, 332 and 334 can then be transmitted to intermediate node 250. Intermediate node 250 can then compile cumulative cost data for channels for delivery of the communication signal to the input to destination node 260, as represented by data arrays 340, 342 and 344. Next, intermediate node 250 can identify the lowest cumulative cost in each of the four elements in data arrays 340, 342 and 344, populate these data arrays with only such minimum cumulative costs for each of the four elements in each data array, and locally store identifications of the specific elements of data arrays 330, 332, and 334 corresponding to such minimum costs.

The minimum cumulative costs in data arrays 340, 342 and 344 can then be transmitted to destination node 260. Destination node 260 can then compile cumulative cost data for all channels for transmission of the communication signal on link 270 and for reception of the communication signal by receiver 220, as represented by data arrays 350, 352 and 354. Next, destination node 260 can identify the lowest cumulative cost in each of the four elements in data arrays 350, 352 and 354. Destination node 260 can then select the absolute lowest cumulative cost in such data arrays considered together. Alternatively, for example, all of the cumulative minimum cost data populated by destination node 260 in data arrays 350, 352 and 354 can be simultaneously compared. Hence, the destination node 260 is in a position to determine the total cumulative cost of the minimum cost path from point 302 to point 304. Destination node 260 also knows the identity of the element of data arrays 350, 352, or 354 used by the least cost path. The information stored in said element of data arrays 350, 352, or 354 can then be transmitted to intermediate node 250 and used to identify the element of data arrays 340, 342, or 344 used by the least cost path. The information stored in said element of data arrays 340, 342, or 344 can then be transmitted to intermediate node 240 and used to identify the element of data arrays 330, 332, or 334 used by the least cost path. The information stored in said element of data arrays 330, 332, or 334 can then be transmitted to source node 230 and used to identify the element of data arrays 320 or 322 used by the least cost path. Source node 230 can then use its knowledge of the identity of the element of data arrays 320 and 322 used by the least cost path, to identify the element of data array 310 used by the least cost path. Hence, this process can continue recursively at each successive node as the reservation signal proceeds from the destination node to the source node, using stored information at a succession of data arrays until the full identity of the least cost path has been revealed. The resulting least cost path represents an optimum resource chain for transmission of the communication signal from the transmitter 210 to the receiver 220.

The identification of the least cost path can be accomplished, moreover, without the need to convey unwieldy quantities of superfluous information between nodes. Instead, for example, destination node 260 receives only twelve cumulative least cost data, each populating one of the four elements in data arrays 340, 342 and 344. Destination node 260 then compiles the costs for transmission of the communication signal over all possible channels on link 270, plus costs for receiving the communication signal at the receiver 220, and selects the lowest total cumulative cost as identifying an optimum resource chain for the communication signal. The lowest cost data in the data arrays identify, for example by the magnitude or array location of such data, the corresponding channels to be taken by the communication signal, including the wavelength for each link, and points of regeneration and wavelength conversion.

The examples described thus far apply to methods and systems in which all of the optical fibers on a given link have the same operational and performance characteristics. That is, transmission on each optical fiber is subject to the same physical impairments, and there is no preference for using one optical fiber over another. In a variation of these methods and systems, the optical fibers on a given link may belong to different classes with different physical impairments, different performance features, and different assigned costs. In this variation, a resource chain must specify not only the wavelength of each channel used, but also the class of optical fiber used for each channel. The trellis of FIG. 3 thus needs to be expanded in order to represent all such resource chains.

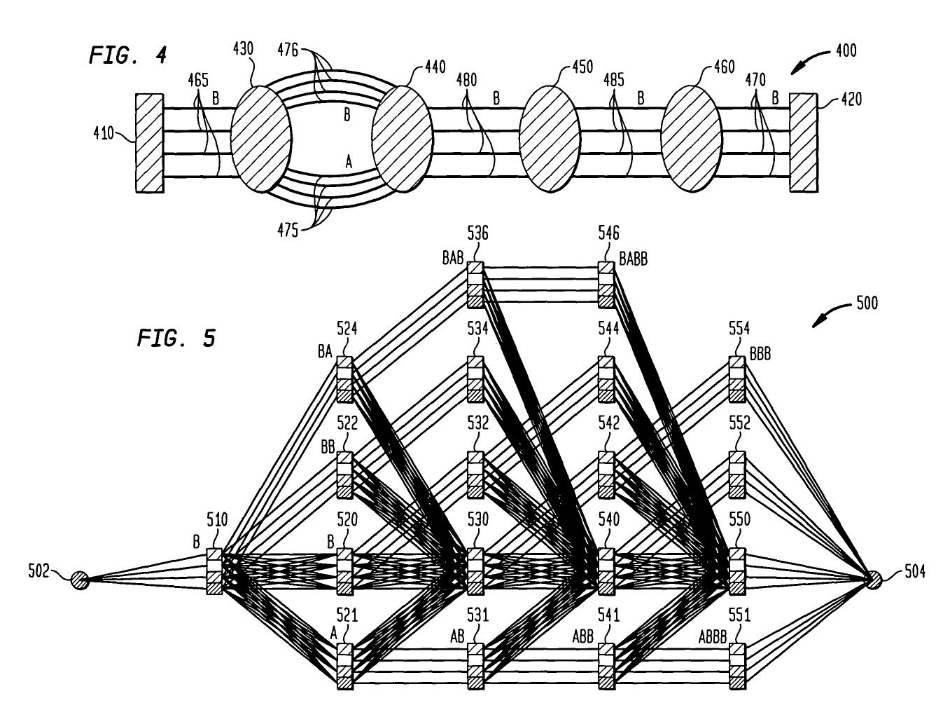

FIG. 4 shows a route 400 that includes a transmitter 410, a receiver 420, a source node 430, two intermediate nodes 440 and 450, and a destination node 460. FIG. 4 further illustrates a set of four channels over link 465 linking transmitter 410 and source node 430, representing four possible wavelengths that may be produced by the transmitter 410. FIG. 4 also shows that source node 430 and intermediate node 440 are connected by two alternative links 475 and 476, provisioned with two different classes A and B of optical fibers, respectively. Class B optical fibers are used over all other links of the route. FIG. 4 additionally illustrates four channels forming links 480, 485, and 470 respectively between intermediate nodes 440 and 450, between intermediate node 450 and destination node 460, and between destination node 460 and receiver 420.

FIG. 5 shows a modified trellis 500 used to represent the possible resource chains for route 400. Most of the data arrays in FIG. 5 are analogous to the data arrays in FIG. 3, since the only difference between FIG. 2 and FIG. 4 is the provision in FIG. 4 of alternative links 475 and 476 between source node 430 and intermediate node 440. For example, point 502 and data arrays 510 and 522 in FIG. 5 respectively correspond to point 302 and data arrays 310 and 322 in FIG. 3. Similarly, point 504 and data arrays 520, 530, 532, 534, 540, 542, 544, 550, 552, and 554 in FIG. 5 correspond to point 304 and data arrays 320, 330, 332, 334, 340, 342, 344, 350, 352, and 354 in FIG. 3, respectively. Data arrays 510, 522, 520, 530, 532, 534, 540, 542, 544, 550, 552, and 554 all represent partial resource chains that have only used class B optical fiber since their last regeneration point. The “A” and “B” labeling in FIG. 5 indicates the types of optical fiber that have been used on the applicable links since the last signal regeneration. The trellis in FIG. 5 has been expanded to also include data arrays 524, 536, 546, 521, 531, 541, and 551. These latter data arrays represent partial resource chains that have used some class A optical fiber since their last regeneration point. Data arrays 520 and 522 represent channels over link 476 using class B optical fiber. Data arrays 521 and 524 represent channels on link 475 using class A optical fiber. Data arrays 524, 536, and 546 represent partial resource chains that do not use regeneration at node 430 and that use class A optical fiber over link 475. Data array 546, for example, uses class B, A, B and B optical fiber over links 465, 476, 480 and 485, respectively. Data arrays 521, 531, 541, and 551 represent partial resource chains that use regeneration at node 430 and class A optical fiber over link 475. Data array 551, for example, uses class B, A, B, B and B optical fiber over links 465, 475, 480, 485 and 470, respectively. In the example shown, the class A optical fiber provides less physical impairment than class B optical fiber, so that signals that use class A optical fibers over link 475 instead of class B optical fibers over link 476 can traverse four links without regeneration instead of only three links.

In an analogous manner, if multiple optical fiber classes are available over other links in route 400, then the data arrays are augmented to represent all possible combinations of optical fiber classes available over such links. Once the augmented trellis is constructed, the computation of the least cost path proceeds in the same manner as in the methods and systems previously described.

In one embodiment according to the present invention, the reservation signal previously discussed stores and transmits the cumulative minimum resource chain cost data populating the data arrays from the source node 230 to the destination node 260. Each node along the route receives such data arrays and replaces them with the cumulative data arrays needed at the next node. The data identifying the corresponding channels and node actions constituting the resource chain are locally stored at the compiling nodes, and need not be transmitted on the reservation signal. After the destination node 260 has identified a minimum cumulative cost in a defined position in the data arrays corresponding to an optimum resource chain for the communication signal, the destination node 260 can reserve its own resources needed for transmission of the communication signal to the receiver 220, and if necessary can confirm reservation by the receiver 220 of any needed resources for receiving the communication signal.

The reservation signal can then store the identity, location within the data arrays, or magnitude of the optimum resource chain for the communication signal, and then be returned by the destination node 260 to the source node 230 via the route 200. When the reservation signal reaches intermediate node 250, intermediate node 250 uses the stored identity, location within the data arrays, magnitude, or other means for identifying the resource chain to identify its own resources needed to transmit the communication signal on the resource chain to destination node 260, and reserves those resources. Similarly, when the reservation signal reaches intermediate node 240, resources are reserved to transmit the communication signal to intermediate node 250. Upon reaching source node 230, the source node can reserve resources needed for transmission of the communication signal to intermediate node 240, and if necessary confirm reservation by the transmitter of any needed resources for transmitting the communication signal to source node 230. The reservation signal can also carry confirmations of the reservations made by each node back to the source node 230. Upon confirmation of the reservation of a complete resource chain for the communication signal, the source node can then instruct the transmitter to transmit the communication signal.

In one variation of the foregoing example, the transmitter 210 or receiver 220 may also receive and analyze data arrays, reserve their own resources, and function in the same manner as nodes. The transmitter 210 and receiver 220 can, for example, take over the respective management functions of the source node 230 and destination node 260. Preferably, source node 230 and destination node 260, analogously to intermediate nodes 240 and 250, nevertheless handle those functions relating directly to communication signal transmission from such nodes. In another embodiment according to the present invention, the cumulative data arrays can be compiled, stored, or analyzed at locations or by systems other than the respective nodes responsible for transmitting the communication signal.

Returning now to FIG. 1, the operations discussed above in connection with FIGS. 2 and 3 can be implemented by the reservation signal initiated at step 120, which is transmitted from the source node 230 to the destination node 260 and then back to source node 230.

At step 130, each of source node 230, intermediate node 240, and intermediate node 250 determines and records in data arrays the minimum added cost of transmitting the communication signal on the next link in route 200 at each potentially available wavelength. Such added costs are determined by applying the designated weighting criteria determined at step 115 to each potential node action and corresponding channel, assigning the resulting cost, determining the least costs, and recording the data in a data array that serves to identify the subject channel as to its wavelength and whether or not regeneration or wavelength conversion are required before the transmission. To such data arrays are added the corresponding cumulative minimum cost data received from the reservation signal for transmission to the input of such node regarding each wavelength. In this manner each such node generates and locally stores data arrays reflecting the cumulative minimum cost for transmitting the communication signal from the transmitter to the subject node at each wavelength plus the cost for transmitting the communication signal from such node on the next link on the route 200. Such data arrays are linked to data identifying the channels as transmitted from such nodes, including whether or not regeneration or wavelength conversion are required before the transmission. The locations of elements in the data arrays are an indication of the regeneration history of the represented channels, so that the nodes can identify the points at which regeneration of the communication signal is necessary.

At step 135 in one embodiment according to the present invention, each of source node 230, intermediate node 240, and intermediate node 250 then provisionally reserves the corresponding channel and node actions in each element of such data arrays for transmission of the communication signal.

At step 140, the data arrays generated by each of source node 230, intermediate node 240, and intermediate node 250 are then added to the reservation signal. Optionally, such data arrays overwrite and replace any data arrays previously added to the reservation signal. At step 145, the reservation signal is then transmitted to the next node along route 200, and steps 130-140 are repeated.

Upon reaching destination node 260, it is necessary to determine not only the added cost of transmitting the communication signal over link 270 for each potentially available channel, but also the added cost for receiving the communication signal at receiver 220 for each potentially available channel. Subject to this modification, step 150 is carried out at destination node 260 in a manner analogous to step 130. At step 155, destination node 260 then determines a minimum cumulative total cost for transmitting the communication signal from transmitter 210 to receipt by receiver 220, and thereby identifies a complete resource chain for the transmission of the communication signal. Destination node 260 also identifies the channel as transmitted from destination node 260, including whether or not regeneration or wavelength conversion are required before the transmission as well as upon reception by the receiver 220. Destination node 260 then reserves the resources needed to transmit the communication signal on the optimum channel over link 270 to the receiver 220. If resources are needed by the receiver, then the destination node either reserves them itself or instructs the receiver to reserve them. Step 155 represents a modification of step 135.

At this point, an optimum resource chain for the communication signal has been identified by the destination node 260 and its location in the data arrays is added to the reservation signal. At step 160, the reservation signal is returned over the route to the source node in order to communicate this information and implement the route to transmit the communication signal.

At step 170, the reservation signal is received and successively processed by intermediate node 250, intermediate node 240, and source node 230. Each such node reads the location of the optimum channel in the data arrays, identifies the corresponding channel and node actions for transmitting the communication signal from such node, reserves the necessary resources, cancels any provisional reservations, and adds such reservation to the reservation signal. In one embodiment according to the present invention, a specification for such corresponding channel and node actions is added to the reservation signal. The reservation signal is then sent to the next node in the series on route 200.

Following or together with completion of step 170 at the source node 230, source node 230 determines whether resources are needed by the transmitter, and then either reserves them itself or instructs the transmitter to reserve them. The source node 230 also confirms from the reservation signal at step 175 that a complete resource chain for the communication signal has been reserved.

At step 180, the source node 230 instructs the transmitter 210 to send the communication signal over the route on the optimum resource chain. In one embodiment according to the present invention, the communication signal carries with it an instruction signal including the optimum resource chain. Source node 230, intermediate nodes 240 and 250, and destination node 260 then read and follow the instruction signal so that the communication signal is properly transmitted.

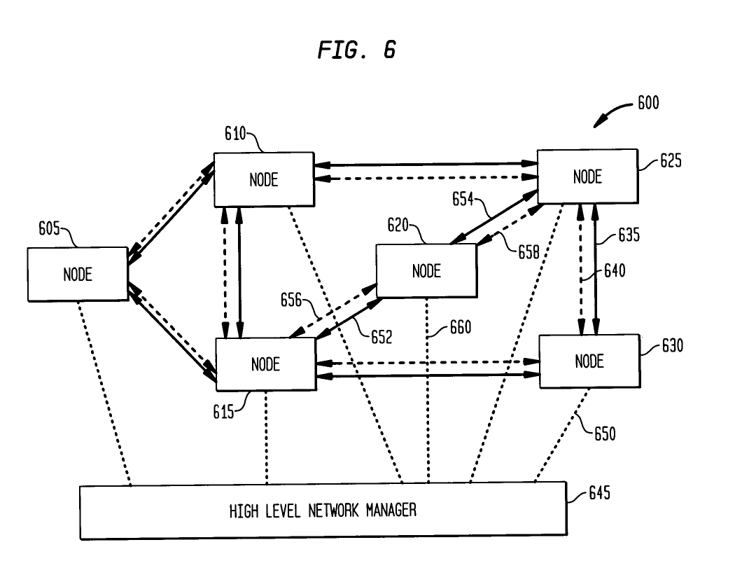

In accordance with the present invention, network systems are provided that implement the methods introduced above. Referring to FIG. 6, an optical network 600 is shown. The exemplary optical network includes nodes 605, 610, 615, 620, 625 and 630. Solid lines designate service network links for the transmission of communication signals among the nodes in the network on the available links such as on link 635 between nodes 625 and 630. Dashed lines designate control network links for the communication of network control signals among the nodes in the network on the available links such as on link 640, also between nodes 625 and 630.

Preferably, the service network links and control network links make parallel connections with the nodes in the network, providing connectivity among the nodes forming a coextensive mesh. The service network links and control network links can be constituted, at any given time across the network or a desired subportion, by separate dedicated optical fibers, by separate designated optical fibers subject to active redesignation, or by shared optical fibers. Alternatively, the control network links may be constituted by a separate communication structure of any type. In the network 600, although the mesh includes numerous links among node pairs, some routes between pairs of nodes are direct while others are by necessity indirect. For example, service network link 635 and control network link 640 provide direct bidirectional communication between nodes 625 and 630. On the other hand, communications originating at node 620 having a termination point at node 610 must pass through node 615 or node 625, and could potentially be routed through nodes 625, 630 and 615. The nodes shown in FIG. 6 further have varying degrees of connectivity with each other. For example, node 615 is provided with direct service and control network links to four other nodes, including nodes 605, 610, 620, and 630. In contrast, each of nodes 610 and 625 is provided with direct service and control network links to three other nodes. Each of nodes 605, 620 and 630 is provided with direct service and control network links to two other nodes.

FIG. 6 further shows that each of the nodes 605-630 is directly connected with a high level network manager 645. For example, link 650 shown as a dotted line connects node 630 with the high level network manager 645. The high level network manager 645 is responsible for overall operation of the network 600, such as network monitoring and provisioning.

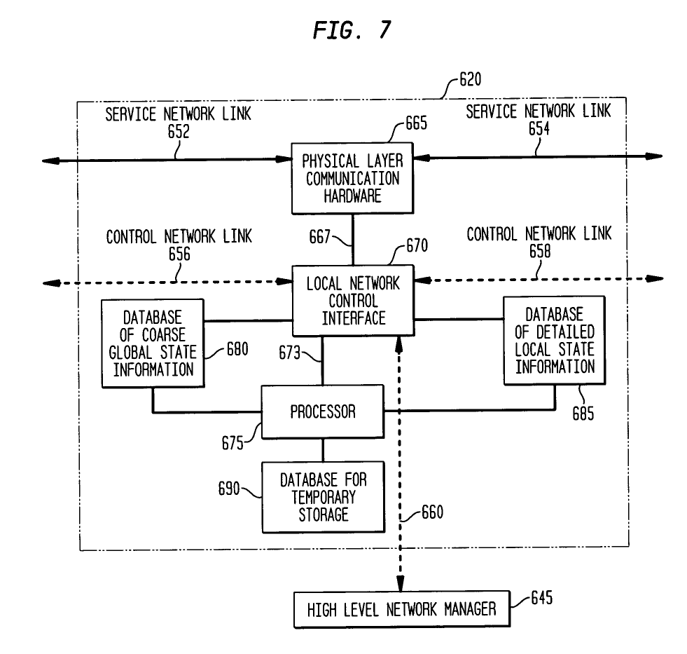

FIG. 7 illustrates further details regarding exemplary node 620 shown in network 600. As shown in both FIGS. 6 and 7, node 620 is provided with service network links 652 and 654, control network links 656 and 658, and link 660 to the high level network manager 645. Referring to FIG. 7, node 620 is further provided with physical layer communication hardware 665. Physical layer communication hardware 665 constitutes the components that receive, process and resend optical communication signals at the node 620, including for example, the optical switch, regenerators, and amplifiers.

Local network control interface 670 is responsible for local control of physical layer communication hardware 665 and for communicating with the network to enable such control, and is connected to the physical layer communication hardware 665 by link 667. Local network control interface 670 is in bidirectional communication with the network through control network links 656 and 658; and with high level network manager 645 through link 660. Local network control interface 670 is in communication via link 673 with a processor 675 for executing the duties of the local network control interface 670. If desired, the processor 675 and local network control interface 670 can be an integral unit.

The local network control interface 670 is also provided with a database of coarse global state information 680 and a database of detailed local state information 685. The database of coarse global state information 680 includes information provided by the high level network manager 645 and through the local network control interface 670 regarding resource availability including channels and regenerators across the network. Such data may be, depending on the network configuration, summarized rather than detailed, as well as historical rather than live, hence the designation of such data as coarse. The database of detailed local state information 685 includes detailed information regarding resource availability at node 620 itself, and may further include detailed information collected by local network control interface 670 regarding resource availability at adjacent nodes 615 and 625 as well as on service network links 652 and 654. The database of detailed local state information 685 is the primary information accessed and stored by node 620 in contributing to determination of resource chains for communication signals in accordance with the present invention.

When changes occur in the network 600, the local network control interface 670 updates the database of detailed local state information 685 with pertinent information, such as the available regenerator capacity in physical layer communication hardware 665 and designation of which channels are available on the adjacent service network links 652 and 654. Coarser information, such as the remaining total number of available channels on such links, is sent over the control network links 656 and 658 to all of the other control interfaces in the network 600, which then record the information in their databases of coarse global state information analogous to database 680.

Node 620 further includes a database for temporary storage 690. As previously explained with regard to FIG. 3, each node along a proposed route for a communication signal computes the minimum cumulative costs for transmission of the communication signal on the adjacent downstream link to the input to the next node in the route. At the same time, each such node records the identities of the corresponding channels on such link, together with information on required regenerations and wavelength conversions. These data are stored in the database for temporary storage 690 in step 130 of FIG. 1.

In order to set up a resource chain originating at node 620 having a termination point at node 630, the high level network manager 645 sends a request to local network control interface 670. Using the database of coarse global state information 680, the node 620 chooses a route through the network 600 to node 630, for example, via node 625. Then the processor 675 is used to initialize determination of the resource chain. As previously explained with regard to FIG. 3, each node along a proposed route for a communication signal computes the minimum cumulative costs for transmission of the communication signal on the adjacent downstream link to the input to the next node in the route. At the same time, each such node records the identities of the corresponding channels on such link, together with information on required regenerations and wavelength conversions. These data are stored in the database for temporary storage 690.

The local network control interface 670 creates a resource chain setup message and forwards it via link 658 on the control network to the next node in the chosen route, that is, node 625. Node 625 receives the resource chain setup message on control network link 658. Trellis weights are defined using detailed local state information at node 625, and then the processor at node 625 is used to do the computations defined in step 130 of FIG. 1 for that node. Node 625 then stores the identities of the corresponding channels to be used on link 635 to node 630, together with information on required regenerations and wavelength conversions, in its database for temporary storage 690.

The resource chain setup message is updated with the newly computed minimum costs for communication signal transmission at a plurality of wavelengths and the resource chain setup message is sent over the control network on link 640 to destination node 630. If further nodes were included in the chosen route then this process would be repeated for those nodes until completed for all nodes along the route to the termination point.

As defined in step 165 of FIG. 1, a reservation message is then sent back from node 630 to node 625 to node 620 over the control network. The message contains the minimum cost channels constituting the selected route for transmission of the communication signal, together with their locations in the data arrays. The processor at each such node uses these data along with the data in the local database for temporary storage to compute the appropriate data to pass back to the next node upstream on the route. At the same time, the local network control interface at each node communicates with the physical layer communication hardware, and configures the hardware to be ready to carry the communication signal.

Upon return of the reservation signal to the local network control interface 670 via control network link 658, for example, the processor 675 retrieves needed data from the database for temporary storage 690, and computes the resource chain elements to be used on link 654. The source node 620 then sets up physical layer communication hardware 665 and begins transmitting the communication signal.

Various types of partially transparent nodal architectures for sharing wavelength converters and regenerators can be used to constitute the physical layer communication hardware in the methods and systems according to the present invention. For example, architecture types that can be used include share per node, share per link, and share with local designs.

In a share per node configuration, there is a pool of R regenerators available for use by any communication signal passing through the node. The corresponding constraint is that the number of signals undergoing regeneration must be less than or equal to R.

In a share per link configuration, there is a pool of Rₖ regenerators for each output link k of the node, that can be shared among signals using that particular output link. The corresponding constraint is that the number of signals undergoing regeneration and then using the k-th output link must be less than or equal to Rₖ, for each link k.

In a share with local designs node configuration, there is a pool of R optical to electronic receivers and a pool of T electronic to optical transmitters., and the pools are connected by an electronic switch. Local drop signals use receivers, local add signals use transmitters, and signals being regenerated use a receiver and transmitter. The constraint is that the number of local drop and regenerated signals must be less than R while the number of local add and regenerated signals must be less than T.

Another partially transparent nodal architecture that can be used is sparse conversion and regeneration, in which a limited number of opaque nodes are scattered throughout an otherwise transparent network. Such an architecture may require more regenerators than a shared regenerator architecture; however, the relative simplicity of the nodes may offset the additional regenerator costs. Generally, increasing the degree of sharing will make the switching equipment required at a given node more expensive, while reducing the required number of regenerators and wavelength converters.

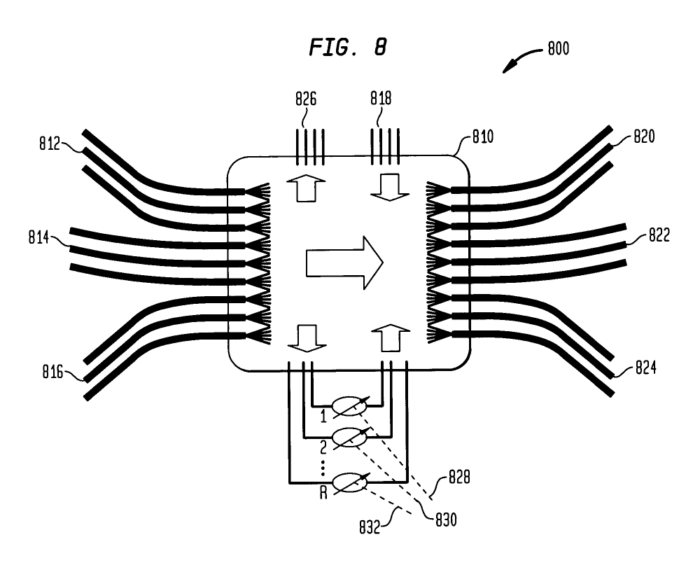

In one preferred embodiment according to the present invention, a share per node configuration 800 as shown in FIG. 8 is employed. In this embodiment, a large space optical cross connect switch 810 is used to connect incoming channels from optical fiber bundles 812, 814 and 816 and local add transmitter group 818 with outgoing channels on optical fiber bundles 820, 822 and 824 and local drop receiver group 826. Additionally, R input and output ports of the switch provide access to R regenerators represented by regenerators 828, 830 and 832, in a loopback fashion. In one flexible scenario, the regenerators, transmitters, and receivers are all completely tunable and thus capable of accessing channels of any wavelength.

In one system embodiment according to the present invention, nodes with fully sharable, tunable regenerators are used. However, many other potentially cheaper architectures can alternatively be employed. In one system embodiment according to the present invention, the network is provided with an equal number of regenerators at every node. Alternatively, per node dimensioning of the regenerator pool sizes can be employed. In another system embodiment according to the present invention, network performance can be improved by using adaptive rather than fixed routing. Adaptive routing can take the form of alternate route evaluation if resource chain assignment is unsuccessful or if the minimum cost through the trellis is too high.

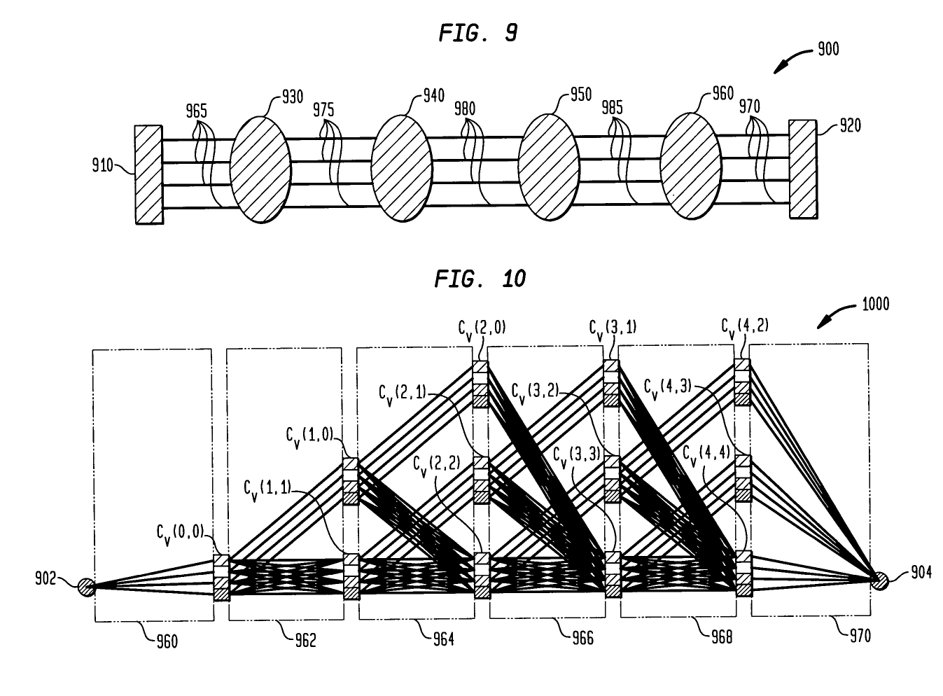

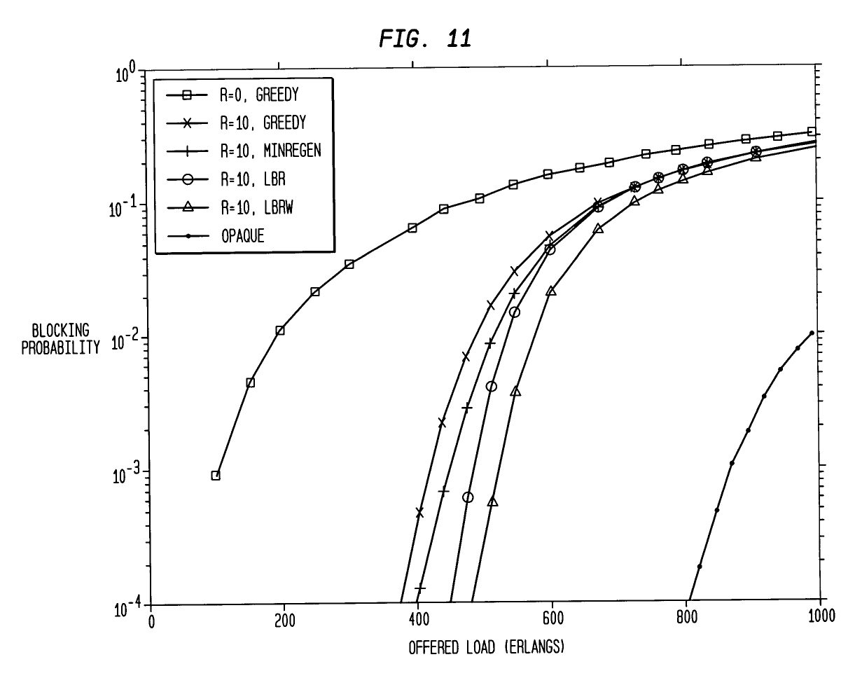

FIGS. 9 and 10 respectively show a four node signal transmission route and a corresponding trellis to which reference will be made to explain mathematics that is useful for implementation of systems and methods in accordance with the present invention. FIG. 9 illustrates a route 900 that includes a transmitter 910, a receiver 920, a source node 930, two intermediate nodes 940 and 950, and a destination node 960. FIG. 9 additionally illustrates four optical fibers forming links 965, 975, 980, 985 and 970, respectively between transmitter 910 and source node 930, between source node 930 and intermediate node 940, between intermediate nodes 940 and 950, between intermediate node 950 and destination node 960, and between destination node 960 and receiver 920.

FIG. 10 shows a trellis 1000 illustrating the potential resource chains on route 900 of FIG. 9, based (a) on an assumption that each optical fiber operates at the same four defined wavelengths and (b) on an assumption that a signal requires regeneration after traversing three links on the route. The points 1002 and 1004 represent transmitter 910 and receiver 920, respectively. Data array Cᵥ(0,0) represents costs of traversing channels 965 from transmitter 910 to the input to source node 930. Data arrays Cᵥ(1,1) and Cᵥ(21,0) represent cumulative costs of traversing links 965 and 975 from transmitter 910 to the input to intermediate node 940. Data arrays Cᵥ(2,2), Cᵥ(2,1) and Cᵥ(2,0) represent cumulative costs of traversing links 965, 975 and 980 from transmitter 910 to the input to intermediate node 950. Data arrays Cᵥ(3,3), Cᵥ(3,2) and Cᵥ(3,1) represent cumulative costs of traversing links 965, 975, 980 and 985 from transmitter 910 to the input to destination node 960. Data arrays Cᵥ(4,4), Cᵥ(4,3) and Cᵥ(4,2) represent cumulative costs of traversing links 965, 975, 980, 985 and 970 from transmitter 910 to the input to receiver 920, and also the costs of being received by receiver 920. The costs of such reception may include, for example, considerations of the channel and wavelength capacities of the receiving equipment at the termination point. Dotted lines define boxes 1060, 1062, 1064, 1066, 1068 and 1070. The solid lines within such boxes indicate channels originated from transmitter 910, source node 930, intermediate node 940, intermediate node 950, and destination node 960, respectively. Given a bandwidth demand from node s (930) to node t (960), the first step is to choose a candidate route. Under the GMPLS source routing protocol, the route is typically computed by the source node s as a capacity constrained minimum weight channel to the termination point, with the link weights inversely related to the spare capacity for each link.

For a given route traversing N nodes, the source node is labeled n₁, the destination node is labeled n_{N} and the intermediate nodes are labeled n₂, . . . , n_{N-1}. Further, n₀denotes the transmitter attached to the source node, and n_{N+1} denotes the receiver at the destination node. The links are labeled l₁, . . . , l_{N-1} so that link lᵢ connects nᵢ to nᵢ₊₁. Link lᵢ consists of Mᵢ parallel optical fibers in each direction, and each optical fiber carries W wavelengths, or channels. In typical networks, Mᵢ=1, but Mᵢ>1 is not uncommon. The detailed link state aᵥ (i)∈{0, . . . , Mᵢ} specifies the number of channels of wavelength v on link l that are not in use. It is important to note that, in a GMPLS based network, this detailed information is available only at nodes nᵢ and nᵢ₊₁.

In the shared regenerator model, there are Rᵢ regenerators provisioned at node nᵢ in a shareable pool. If the regenerators are fully tunable, the node state is given by the number of available regenerators b(i)∈{0, . . . , Rᵢ}. Other models may require different node state information. For example, if the regenerators have fixed or otherwise limited output wavelengths, then bᵥ(i)∈{0, . . . , R_{v,i}} could represent the number of regenerators capable of producing wavelength v.

Methods of measuring and estimating physical impairments in optical networks are conventionally employed to determine applicable reach constraints at each node in the selected route during the route reservation and resource chain assignment phase. In particular, node nᵢ in the route needs to know the index of all previous nodes nⱼ such that signals regenerated at nⱼ can transparently reach node nᵢ. If node nⱼ can transmit to node nᵢ, then so can nodes nⱼ₊₁, . . . , nᵢ₋₁. The reach constraints can then be summarized by the reach function g(i)<i, where g(i) is the lowest index among nodes that can transmit directly to node nᵢ. The reach constraints can be specified offline, or computed online as part of the resource chain assignment process.

Where offline computation of reach constraints is desired, the set of all reach constraints in the network is explicitly specified in advance. Each node stores a list of all feasible transparent routes leading to it, which accordingly do not require regeneration. For most practical topologies, this will be a manageable list to store, although in a highly interconnected network with long transparent routes, such a list could become unmanageable. Upon receiving a resource chain reservation message identifying a prospective route, each node in the route can use its reach constraint list to determine g(i).

Where offline computation of reach constraints is desired, each network element in the route may have a pre-assigned vector of additive values that keeps track of impairments such as noise, dispersion, or the number of nodes passed through by a communication signal. As the resource chain reservation message propagates forward, a cumulative list of these vectors is generated. Then g(i) can be computed based on predetermined engineering rules.

In the exemplary embodiments shown in FIGS. 9 and 10, the propagation constraints are such that no more than three links can be traversed by the communication signal without regeneration, that is, g(i)=max{i−3,0}. The vertices in FIG. 10 correspond to channels in FIG. 9, and the arcs correspond to nodal actions in FIG. 9. The first vertex in the trellis, v^{a}, corresponds to a transmitter attached to the source node, and the last vertex v^{d} represents a receiver at the destination node. At each of the five stages in between, there is a column of vertices representing the channels with accompanying node actions, that can be used between the transmitter and source node, on each of the three links, and between the destination node and receiver. The vertices in the i-th stage of the trellis are labeled vᵥ(i,j). For i=1, . . . , N−1, such a vertex represents a signal carried across link lᵢ on wavelength v, given that the signal was last regenerated at node nⱼ. Hence for a given i,j can range from g(i+1) up to i. In the case i=0, the vertex represents the departure of the signal from the transmitter, and for i=N, the vertices represent the signal entering the receiver.

There are two types of edges shown in FIG. 10. The first type of edges are transparent edges, which connect the vertex vᵥ(i−1,j) with the vertex vᵥ(i,j), and represent choosing to allow the signal to pass through node nᵢ without regeneration. Transparent edges are assigned the weight wᵥ(i)=tᵥ(i)+fᵥ(i), where tᵥ(i) is a through cost typically having a value of zero, and fᵥ(i) is a link cost. The second type of edges, opaque edges, connect vertices v_{μ}(i−1,j) with vertices of the form vᵥ(i,j), and represent choosing to regenerate the signal at node nᵢ. Opaque edges are assigned the weight w_{μ,v}(i)=r_{μ,v}(i)+fᵥ(i), where r and f are regeneration and link costs, respectively. The weights for signal adding and dropping, denoted wᵥ^{a} and wᵥ^{d}, connect to the transmitter vertex v^{a} and receiver v^{d}. The set of potential resource chain assignments from the transmitter Tx to the destination Rx in FIG. 9 are in one to one correspondence with the set of paths through the trellis.

Costs associated with impossible actions are set to be infinite. For example, r_{μ,v}(i) is infinite if regeneration with conversion from wavelength μ to v is unavailable at nᵢ. Further, tᵥ(i) is infinite if node i is an opaque node. Here r_{μ,v}(i) is a node cost, which for μ≠v is used to quantify the cost of using a regenerator at node nᵢ, while changing from wavelength μ to wavelength v. The link cost fᵥ(i) represents the cost of traversing link lᵢ using a channel of wavelength v; and fᵥ(N)=0. Regeneration typically requires the same resources regardless of whether or not wavelength conversion takes place.

Exemplary weighting algorithms that can be selected and used in the systems and methods according to the present invention include: minimum regenerators (MR); load balance regenerators (LBR); minimum regeneration load balancers (MRLB); and load balance regenerators and wavelengths (LBRW). In each case, resource chain assignment is performed by finding the minimum cost path through the trellis. The only difference between them lies in the definition of the edge weights. In employment of all of these algorithms in the systems and methods according to the present invention, unavailable resources are given infinite cost, and all other weights not specified below are set to zero. Mathematically, such weighting algorithms can be implemented as follows:

MR: Set r_{μ,v}(i)=1 for all μ and v.

LBR: Set r_{μ,v}(i)=1/b(i) for all μ and v.

MRLB: Let Z be a number larger than N. Set r_{μ,v}(i)=Z+1/b(i) for all μ and v.

LBRW: Set r_{μ,v}(i)=1/b(i) for all μ and v and set fᵥ(i)=K/a(i) for all v. Define K as a constant quantifying the relative importance to the network of regenerator and wavelength load balancing.

MR minimizes the number of regenerators used along the route. LBR prioritizes avoidance of the use of regenerators at nodes that have few regenerators available, and secondarily minimizes use of regenerators. MRLB minimizes the number of regenerators used, but breaks ties by prioritizing considerations of load balancing. LBRW modifies LBR by preferentially using channels at the same wavelength that are available on multiple optical fibers. LBRW reduces to LBR when each link consists of a single optical fiber, that is when Mᵢ=1.

Given a route, the above approaches are employed in the systems and methods according to the present invention in order to construct an auxiliary graph in the form of a trellis. Dynamic programming is then used to find the least cost path across the trellis. The dynamic programming proceeds by computing costs in a forward sweep from Cᵥ(0) up to Cᵥ(h−1) and finally the overall cost C(N+1). A backward sweep of the method then reconstructs the path that achieves the minimum cost.

It is important to note that the trellis is never actually constructed at any particular location in the network. Instead, each node in the route maintains one stage of the trellis, the cumulative costs are passed forward, and the decisions are passed backward.

The methods and systems according to the present invention operate by finding the least cost path through the trellis. The complexity of the procedures is minimized due to the special structure of the trellis weights, and takes advantage of the fact that the arc weights do not depend on the index j of the leading vertex vᵥ(i−1,j). At each stage, the cost Cᵥ(i,j) represents the minimum cost of leaving node nᵢ on wavelength v, given that regeneration was last performed at node nⱼ.

Upon initialization of execution, for each wavelength v, the source node sets Cᵥ(0,0)=wᵥ^{a}.

During the forward pass of the reservation signal from source node 930 to destination node 960, node nᵢ, 1≦i≦N receives as input the costs Cᵥ(i−1,j) for j=g(i), . . . , i−1 and proceeds to compute Cᵥ(i,j) for j=g(i+1), . . . , i. The costs for choosing to allow the communication signal to pass through node i without regeneration are given by:

Cᵥ(i,j)=Cᵥ(i−1,j)+wᵥ(i),

for j=g(i+1), . . . , i−1. To compute the cost of channels that are regenerated at node nᵢ, the following computations are made:

$$\begin{matrix}{\overline{C}}_{v} ( i - 1 ) = {min}_{j} {C}_{v} ( i - 1 , j ) \\ and \\ {k}_{v}^{*} ( i ) = arg {min}_{j} {C}_{v} ( i - 1 , j )\end{matrix}$$

where j ranges over g(i)≦j≦i−1. For each v, the first computation determines the minimum cost to reach node nᵢ, assuming that wavelength v is used on link i−1. The second computation determines the node at which the minimum cost signal was last regenerated. Next, the following computations are made:

$$\begin{matrix}{C}_{v} ( i , i ) = {min}_{μ} [ {\overline{C}}_{μ} ( i - 1 ) + {w}_{μ , v} ( i ) ] \\ and \\ {μ}_{v}^{*} ( i ) = arg {min}_{μ} [ {\overline{C}}_{μ} ( i - 1 ) + {w}_{μ , v} ( i ) ]\end{matrix}$$

These computations determine the minimum cost for the signal to leave node nᵢ on wavelength v, among channels that are regenerated at node nᵢ. If i=N, the method moves to the final wavelength selection step. Otherwise, the costs Cᵥ(i,.) are forwarded to node nᵢ₊₁. If all of the costs are infinite, then the resource chain assignment is infeasible. In such a case, the method is terminated and a failure message is sent back to the source node.

Upon completion of the forward pass of the reservation signal, a resource chain for the signal is determined. Once node n_{N} has computed the costs Cᵥ(N), it computes

$$\begin{matrix}{\overline{C}}_{v} ( N ) = {min}_{j} {C}_{v} ( N , j ) \\ and \\ {k}_{v}^{*} ( N + 1 ) = arg {min}_{j} {C}_{v} ( N , j )\end{matrix}$$

for j ranging over g(N+1)≦j<N+1. The minimum overall cost and the associated resource chain are determined by

$$\begin{matrix}C ( N + 1 ) = {min}_{v} [ {\overline{C}}_{v} ( N ) + {w}_{v}^{d} ] \\ and \\ {v}^{*} ( N + 1 ) = arg {min}_{v} [ {\overline{C}}_{v} ( N ) + {w}_{v}^{d} ]\end{matrix}$$

Ties are arbitrarily broken. For example, a random choice can be made, or a preset prioritization can be applied. Next, the following computation is made:

j*(N+1)=k*_{v*(N+1)}(N+1)

In this computation, a channel of wavelength v*(N+1) will be used to carry the signal from node j*(N+1) to the receiver, with no intermediate regeneration.

During the reverse pass of the reservation signal from destination node 960 to source node 930, node nᵢ receives j*(i+1) and v*(i+1) from node nᵢ₊₁. When i=0, the reverse pass is complete. The communication signal will then be launched from the transmitter on wavelength v*(1). Otherwise, if j*(i+1)<1, no regeneration is performed at the i-th node, and the parameters j*(i)=j*(i+1) and v*(i)=v*(i+1) are passed back to node nᵢ₋₁. On the other hand, if j*(i+1)=i, then regeneration is used at this node. For i>0, the new parameters passed back are

j*(i)=k*_{v*(i+1)}(i)

and

v*(i)=μ*_{v*(i+1)}(i).

The communication signal will enter node nᵢ on a channel of wavelength v*(i) and exit the node on a channel of wavelength v*(i+1).

The complexity of the methods and systems in accordance with the present invention can be characterized in terms of required data storage, communication, and computation. The overall complexity is the sum of the complexity incurred by each of the nodes in the path. For a particular node nᵢ, the complexity depends on the trellis depth d(i), which is defined to be the number of previous nodes that can reach node nᵢ₊₁, and can be expressed by the formula, d(i)=(i+1)−g(i+1).

The storage requirement refers to the amount of information that must be stored in the database for temporary storage of each node between the forward and backward passes during execution of the resource chain determination. Node nᵢ must store the parameters μ*ᵥ(i) and k*ᵥ(i) computed from the previously discussed formulae,

$${k}_{v}^{*} ( i ) = arg {min}_{j} {C}_{v} ( i - 1 , j ) and {μ}_{v}^{*} ( i ) = arg {min}_{μ} [ {\overline{C}}_{μ} ( i - 1 ) + {w}_{μ , v} ( i ) ]$$

where v={1, . . . , W}. The communication complexity of this storage is O{W}.

The communication requirement refers to the amount of information that must be passed from one node to another in the forward and backward sweeps during determination of the resource chain. In the forward pass, node nᵢ sends to node nᵢ₊₁ the parameters Cᵥ(i,j), where v={1, . . . , W} and j={0, . . . , d(i)}. In the backward pass, only the two values j*(i) and v*(i) must be transmitted. The communication complexity is therefore O{Wd(i)}.

The computation requirement refers to the number of basic operations required at each node, such as comparison, multiplication, and division. Virtually no computation is required in the backward pass. In the forward pass, computation in the formula, Cᵥ(i,j)=Cᵥ(i−1,j)+wᵥ(i), requires O{Wd(i)} addition operations, while computations in the two formulae,

$${\overline{C}}_{v} ( i - 1 ) = {min}_{j} {C}_{v} ( i - 1 , j ) and {k}_{v}^{*} ( i ) = arg {min}_{j} {C}_{v} ( i - 1 , j ) ,$$

require W minimizations across d(i) values, using O{Wd(i)} comparisons. In general, computations in the two formulae,

$${C}_{v} ( i , j ) = {min}_{μ} [ {\overline{C}}_{μ} ( i - 1 ) + {w}_{μ , v} ( i ) ] and$$

$${μ}_{v}^{*} ( i ) = arg {min}_{μ} [ {\overline{C}}_{μ} ( i - 1 ) + {w}_{μ , v} ( i ) ] ,$$

require W² additions and W minimizations over W values, leading to O{W²} complexity.

In the common special case where the cost w_{μ,v}(i) does not depend on μ, such cost is denoted as w_{X,v}(i). Further in this special case, the formulae,

$${C}_{v} ( i , j ) = {min}_{μ} [ {\overline{C}}_{μ} ( i - 1 ) + {w}_{μ , v} ( i ) ] and$$

$${μ}_{v}^{*} ( i ) = arg {min}_{μ} [ {\overline{C}}_{μ} ( i - 1 ) + {w}_{μ , v} ( i ) ]$$

are replaced by the equations,

$${μ}^{*} ( i ) = arg {min}_{μ} {\overline{C}}_{μ} ( i - 1 )$$

$${μ}_{v}^{*} ( i ) = {μ}^{*} ( i ) , \qquad v = \{ 1 , … , W \}$$

$${C}_{v} ( i , i ) = {\overline{C}}_{{μ}^{*} ( i )} ( i - 1 ) + {w}_{X , v} ( i )$$

which have complexity O{W}. Thus, in the general case the overall complexity computation is O{Wd(i)+W²}, while in the special case where the cost w_{μ,v}(i) does not depend on μ, the computation is O{Wd(i)}. The complexity of the final wavelength selection step is the same as the per node complexity of each forward pass step.

In order to investigate the effectiveness of the resource chain assignment methods and systems according to the present invention, a network simulation was created in which resource chain requests randomly arrived, were set up for transmission if possible, and then were taken down at random. Blocked resource requests were cleared. The steady state probability of blocked requests was measured under varying network parameters and using various resource chain assignment methods. The arrival of unidirectional resource chain signal requests followed a Poisson process with a constant rate λ, and signal holding times were exponentially distributed with mean H. The blocking probability depended on these quantities through the product λH, referred to as the offered load, in erlang units.

Each node had the same number of regenerators Rᵢ=R in a shareable pool. Both fixed and tunable add transmitters were considered. In the case of fixed transmitters, each demand could only be added at a particular wavelength, chosen at random. A shared regenerator at the source node could be used for wavelength conversion if needed. Tunable transmitters were free to add the signal at any desired wavelength.

Two different network configurations were studied. One configuration was a 14 node ring with uniform traffic. The second configuration was a generic mesh network such as might be used to transport data between major cities in the United States. The mesh network included 30 nodes, 38 links, and a non-uniform traffic matrix. Further in the mesh configuration, each node was directly linked to an average of 2.5 other nodes, that is, the network had an average degree of 2.5. In both network configurations, every link was bidirectional and consisted of four pairs of optical fibers, where the optical fibers in each pair carried unidirectional signals in opposite directions, with 40 wavelengths constituting 40 channels carried on each optical fiber.

The simulations were executed at a protocol level, which included the creation of signal resource chain messages and the passage of information between nodes. In the simulations, implementations of methods according to the present invention using three different resource chain assignment algorithms including MR, LBR and LBRW were compared with each other and with a conventional system implementing a greedy algorithm.

The conventional greedy algorithm, which was included in these simulations for comparison purposes, is so called because in every step it seeks to go as far as possible without wavelength conversion or regeneration. As part of the RSVP-TE reservation protocol, the source node generates a signal resource chain message, including a label set object that identifies the set of wavelengths that can be used by the transmitter. As this message traverses each successive node in the resource chain, the i-th node removes from the label set any wavelengths that are not available on the next link, that is, for which av (i)=0, and forwards the modified label set to its downstream neighbor. If at any point the label set is empty, then wavelength blocking has occurred, and regeneration is required. Also, if at any point reach constraints would be exceeded on the next link, regeneration is required. If no regenerator is available at that point, that is, b(i)=0, then the signal resource chain request is blocked. Otherwise, a regenerator is reserved, and the node creates a new label set containing the set of wavelengths to which the regenerator can tune and which are available on the next link. The label set propagates in this way until it reaches the termination point. In the reverse pass, the termination point chooses from among the available wavelengths in the label set, arbitrarily or in some pre-specified order, and sends a reservation message back toward the origination point. Each node at which a regenerator is used likewise chooses a wavelength from its label set, until the resource chain assignment is complete. If execution of the method using the greedy algorithm successfully finds a resource chain to be assigned, it does so with the minimum possible number of regenerators. However, the method may fail unnecessarily when a regenerator is not available at a particular node but is available at an earlier node in the resource chain.

Reach constraints were defined for the simulations by simply specifying D, the maximum number of intermediate nodes that could be traversed without regeneration. Each channel thus crossed at most D+1 links before being regenerated. The share per node configuration, previously explained, was used.

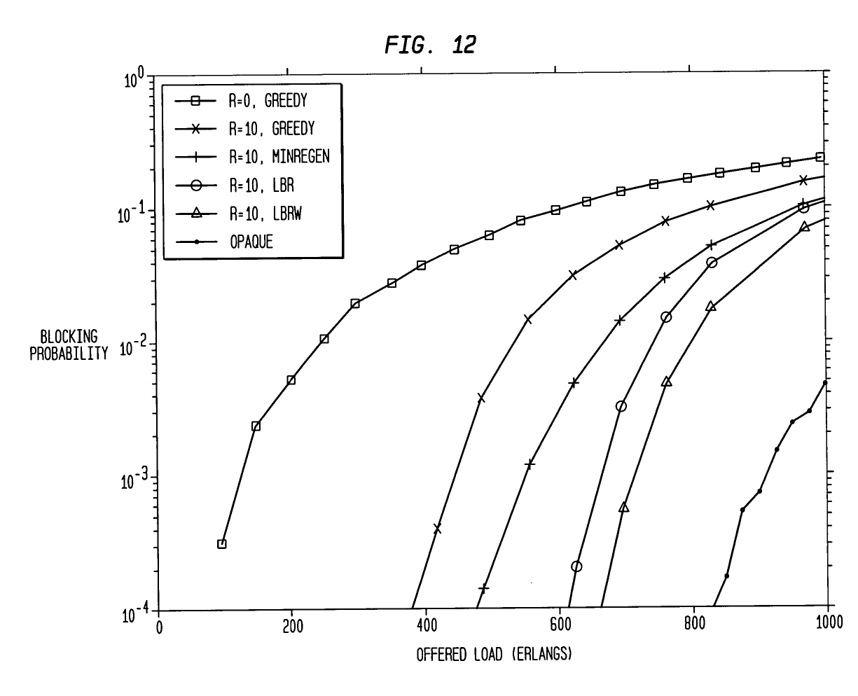

The performance of the methods and systems according to the present invention was first examined for cases in which the source transmitters had fixed output wavelengths, but could access the source node regenerator pool for wavelength conversion as necessary. FIGS. 11 and 12 show the blocking probability for the ring and mesh network simulations respectively as a function of the total offered load in erlangs, when there are no reach constraints in the network. The left-most curve on each graph depicts the equivalent performance of implementations using the four algorithms in a transparent network. The four middle curves depict the performance of implementations of the four resource chain assignment algorithms when there are Rᵢ=10 regenerators per node. Finally, the rightmost curve represents the performance of an opaque network, for which resource chain assignment is irrelevant. Fixed transmitters and completely transparent networks are not a viable combination. However, a small number of regenerators or wavelength converters can go a long way in improving the network capacity. It can further be observed that the method and system performance improves from selected algorithm use from greedy to MR to LBR to LBRW.

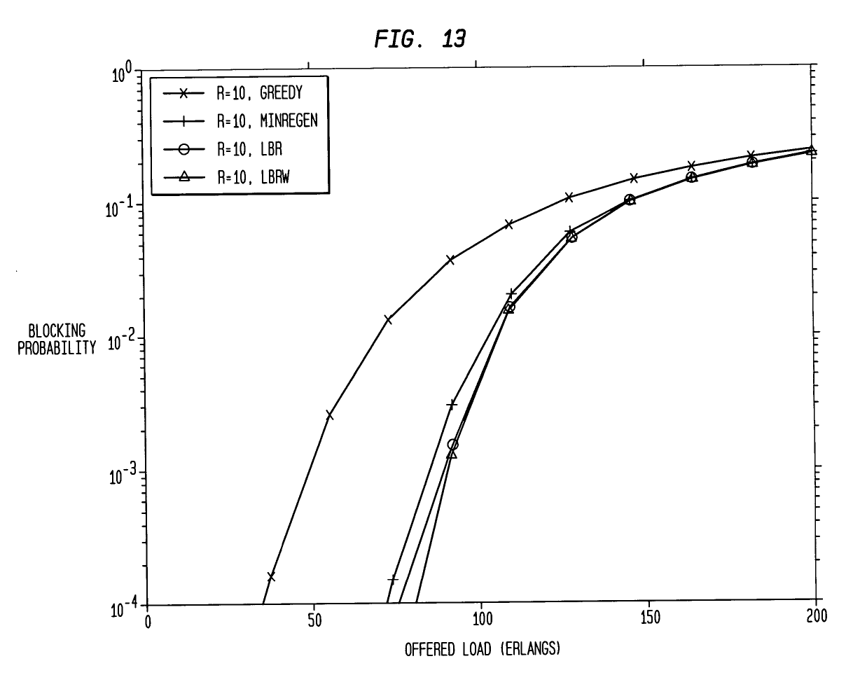

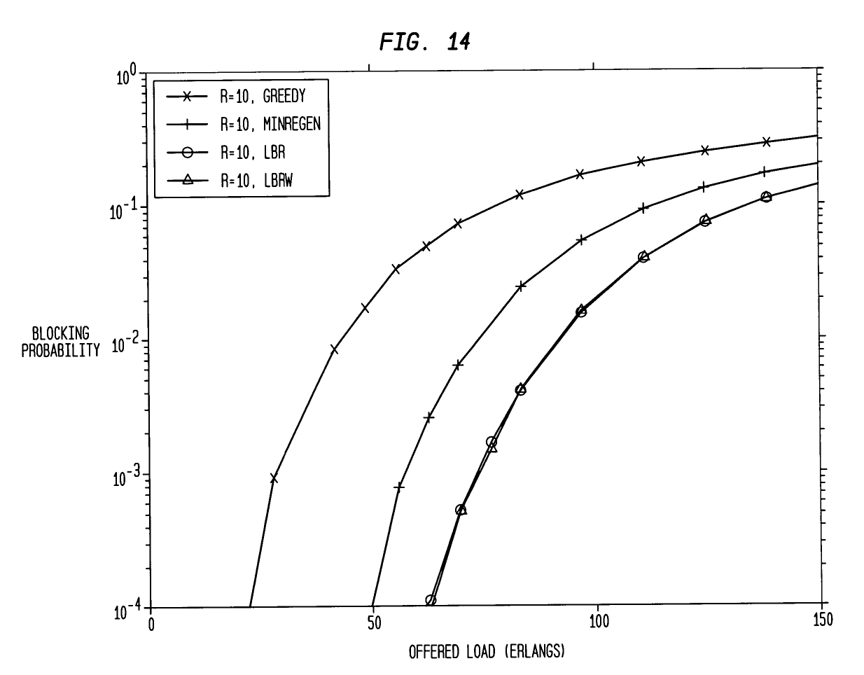

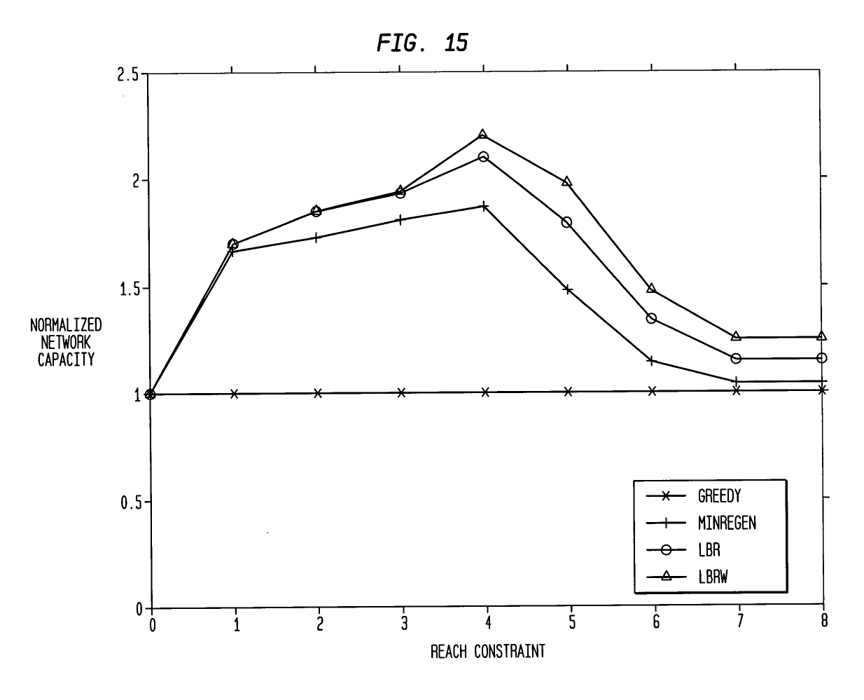

FIGS. 13 and 14 show the same scenario as discussed with regard to FIGS. 11 and 12 for ring and mesh networks respectively, except that a reach constraint of D=2 has been introduced. In the systems as defined, there are only 10 regenerators per node. Since each channel must use a regenerator in at least one out of every three nodes, the networks are in a severely regeneration limited state, and the capacity is severely reduced by the reach constraints. At a fixed blocking level of 10⁻⁴, the MR, LBR and LBRW algorithms gave nearly twice as much capacity as the greedy algorithm on the ring, and nearly three times as much capacity in the mesh network.

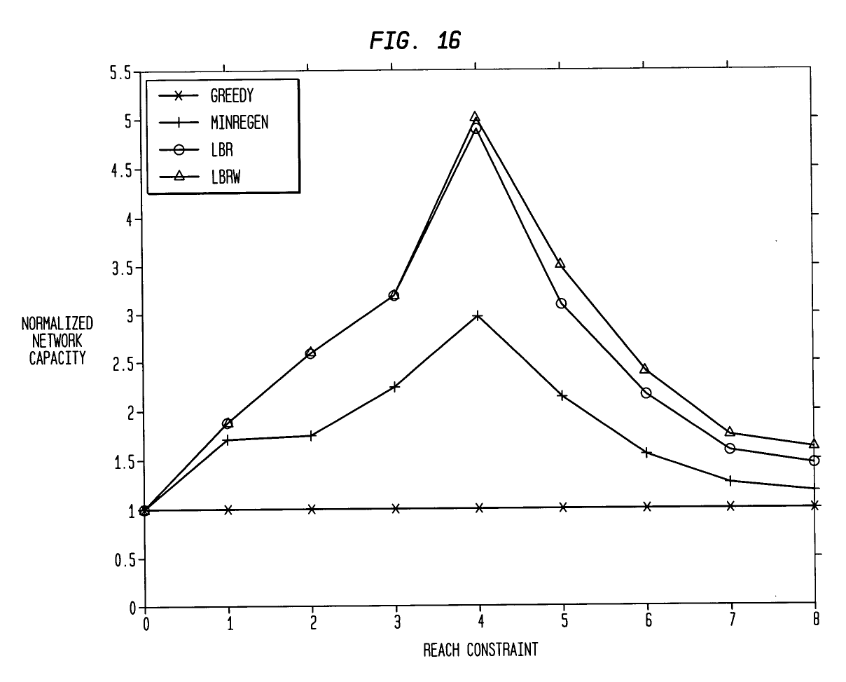

FIGS. 15 and 16 show how the normalized network capacity improvement relative to the greedy algorithm changes as a function of the global reach constraint D. FIGS. 15 and 16 relate to ring and mesh networks having 10 regenerators per node, respectively. Capacity is defined as the maximum offered load resulting in blocking below 10⁻⁴, and reach constraints are specified by the maximum number of links traversable without regeneration. When D is very small, the constraints do not leave the methods much room for choice. As the reach constraint relaxes, the use of the MR, LBR and LBRW algorithms takes much better advantage of this freedom than does the greedy algorithm. In the mesh network, use of the LBRW algorithm results in 4 times the capacity generated by use of the greedy algorithm when D=4. As the reach constraints are further relaxed, propagation constraints eventually cease to dominate, and blocking is instead dominated by optical fiber capacity and wavelength blocking. In this regime, the regenerators are being used exclusively for wavelength conversion, as in FIGS. 11 and 12. The relative capacity improvement is less in this case, but improvement through use of the LBRW algorithm of about 50% in the mesh network is still significant.

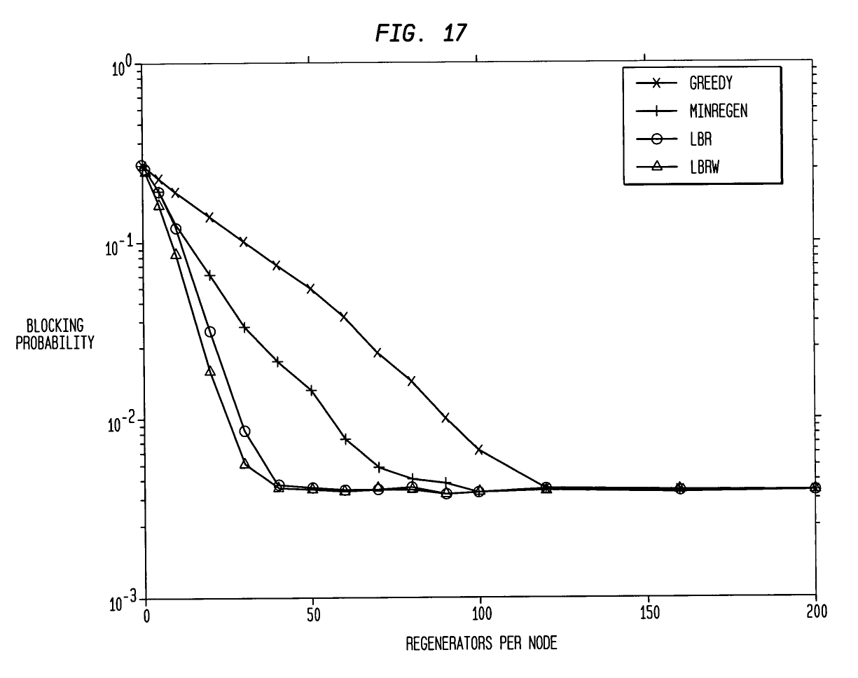

Another way to quantify the performance of the methods and systems according to the present invention is by measuring, for a fixed offered load, the number of regenerators needed to reduce the blocking probability to an acceptable level. FIG. 17 shows this decrease in blocking probability as the number of shared regenerators at each node increases, for mesh networks with no reach constraints. For methods and systems implementing each process, the blocking probability is highest for the transparent network where Rᵢ=0, and decreases until it bottoms out at the blocking level that would be experienced by an opaque network. For the ring, Rᵢ=2MᵢW=320. In the case of a transparent network, there is no choice in wavelength assignment due to the fixed transmitters, hence methods and systems implementing any of the processes perform equally. Likewise, resource chain assignment is irrelevant in the opaque extreme. Between these two extremes, a method or system according to the present invention employing a good resource chain assignment approach can reduce the number of regenerators needed to reach a given blocking level.

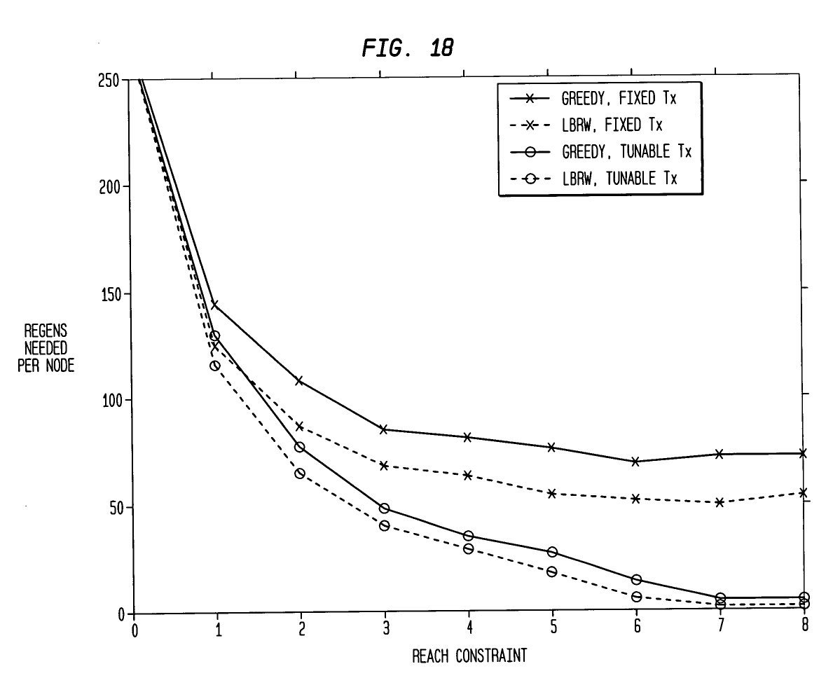

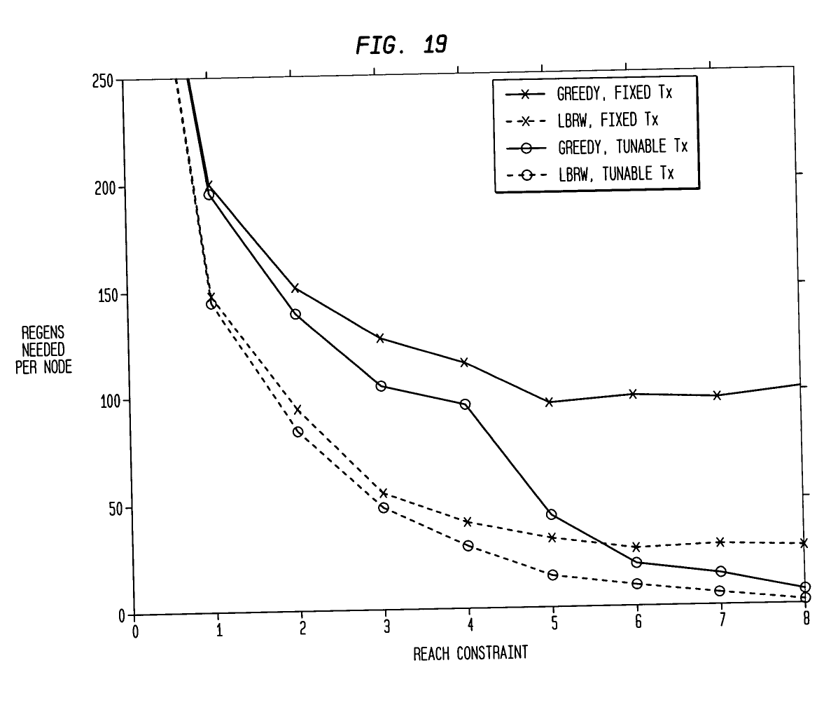

In FIGS. 18 and 19, the efficiency of the methods and systems according to the present invention is quantified by determining the number of regenerators needed to make a partially transparent network effectively equivalent to its opaque counterpart. Specifically, for each network, the opaque capacity was determined, that is, the maximum offered load resulting in less than 1% blocking. After fixing the offered load to 90% of the opaque capacity, the minimum number of regenerators per node required in order to stay below 1% blocking was determined. FIGS. 18 and 19 show the required number of regenerators per node as a function of reach constraint D for the greedy and LBRW algorithms, with separate results indicated for fixed and tunable transmitters. FIGS. 18 and 19 relate to ring and mesh networks, respectively. As the reach constraints were relaxed, fewer regenerators were required. In the case of tunable transmitters, the number of regenerators per node dropped almost to zero, indicating that wavelength blocking was not a significant problem in these networks in the tunable case, although unfairness in blocking with respect to resource chain length could still be a problem.

When transmitters were fixed, methods and systems employing the LBRW algorithm were consistently better than the greedy approach for all reach constraints D>0. The gap between results for scenarios respectively implementing the LBRW and greedy algorithms was particularly large for the mesh network, but was still significant in the ring network. When transmitters were made completely tunable, systems and methods according to the present invention employing the greedy and LBRW algorithms performed almost equivalently in the ring. In the mesh network, systems and methods employing the greedy and LBRW algorithms performed similarly when the reach constraints were loose, but around D=4, systems and methods employing LBRW again performed much better than did systems and methods employing the greedy algorithm.

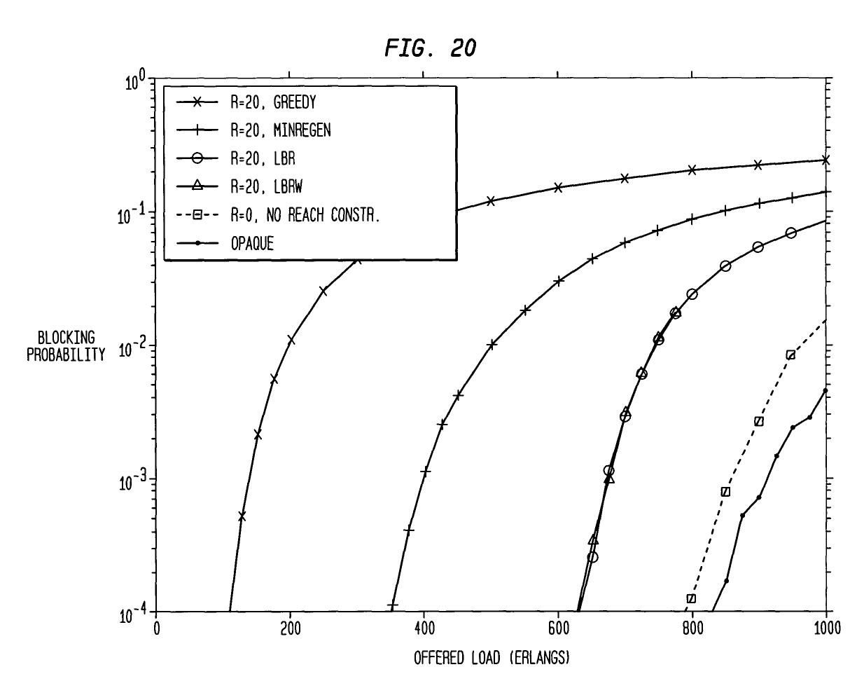

FIG. 20 shows performance results for a mesh network with tunable converters in more detail, in a plot of blocking probability versus offered load in erlangs. The two right-most curves show that, when there were no reach constraints, the transparent and opaque networks had very similar characteristics, and that wavelength blocking was not significant. The existence of four parallel optical fibers on each link contributed to reducing the need for wavelength conversion. In contrast, when the reach constraint was set to D=4, a transparent network was no longer an option. With Rᵢ=20 regenerators per node, systems and methods employing the load balancing algorithms provide much greater capacity than systems and methods employing the greedy or MR algorithms.

While the present invention has been disclosed in a presently preferred context, it will be recognized that the present teachings may be adapted to a variety of contexts consistent with this disclosure and the claims that follow. For example, the systems and methods according to the present invention for assignment of resources through an optical fiber network can be adapted to a network of any desired size, type, complexity, or data array configuration; and can employ any desired algorithm for prioritization of chosen resources.

We claim:

1. A method of assigning a resource chain for transmission of a communication signal from an origination point to a termination point, comprising:
defining an origination point, a node and a termination point, interconnected by optical fiber channels each constituted by a defined wavelength on an optical fiber, collectively constituting a route to be evaluataed for transmission of a communication signal from said origination point to said termination point;
determining first minimum costs of transmitting said communication signal from said origination point to said node by using a plurality of first channels, and identifying potential first channels corresponding to said first minimum costs;
determining second minimum costs of transmitting said communication signal from said node to said termination point by using a plurality of second channels, and identifying potential second channels corresponding to said second minimum costs;
combining said first and second minimum costs and determining a plurality of cumulative minimum costs of transmitting said communication signal from said origination point to said termination point on a plurality of channels, and identifying a lowest cumulative minimum cost and corresponding selected first and second channels; and
transmitting said communication signal from said origination point to said termination point on said selected first and second channels.

2. The method of claim 1 in which said optical fiber channels are carried on a plurality of optical fibers.

3. The method of claim 1 in which a reservation signal is provided to store and transmit said first minimum costs.

4. The method of claim 1 in which a plurality of routes are evaluated to yield a plurality of lowest cumulative minimum costs, and the smallest of said lowest cumulative minimum costs is used in order to identify corresponding selected first and second channels.

5. The method of claim 1 in which said first and second minimum costs are determined by taking into account needs for regeneration of said communication signal.

6. The method of claim 1 in which said first and second minimum costs are determined by taking into account a preference for avoiding regeneration of said communication signal.

7. The method of claim 1 in which said first and second minimum costs are determined by taking into account the availability of capacity for signal regeneration at said origination point and said node.

8. The method of claim 1 in which said first and second minimum costs are determined by taking into account the availability of capacity for signal wavelength conversion at said origination point and said node.

9. The method of claim 1 in which said first and second minimum costs are determined by taking into account the availability of each of said plurality of first and second wavelengths on a plurality of optical fibers.

10. The method of claim 1 in which said first and second minimum costs are determined by taking into account the total availability of channels at said origination point and node.

11. The method of claim 1 in which said first and second minimum costs are determined by taking into account a preference for avoiding signal wavelength conversion.

12. The method of claim 1 in which said lowest cumulative minimum cost is identified at said termination point.

13. The method of claim 1 in which said origination point identifies said selected first channel.

14. The method of claim 1 in which said node identifies said selected second channel.

15. The method of claim 1 in which said node identifies said selected first and second channels.

16. The method of claim 1 in which said reservation signal is directed to a central location for identification of said selected first and second channels.

17. The method of claim 1 in which the presence of physical impairments on said route is verified before evaluation of said route.

18. The method of claim 1, in which said origination point stores said first minimum costs and potential first channels corresponding to said first minimum costs.

19. The method of claim 1, in which said node stores said second minimum costs and potential second channels corresponding to said second minimum costs.

20. The method of claim 3 in which said reservation signal is transmitted from said origination point to said termination point.

21. The method of claim 3 in which said reservation signal stores said cumulative minimum costs.

22. The method of claim 4, in which network signals are provided and analyzed to select a plurality of potential routes for evaluation.

23. The method of claim 12, in which said reservation signal is transmitted from said termination point to said origination point.

24. The method of claim 18, in which said origination point provisionally reserves said potential first channels corresponding to said first minimum costs.

25. The method of claim 19, in which said node provisionally reserves said potential second channels corresponding to said second minimum costs.

26. The method of claim 23, in which said node finally reserves said second channel, said origination point finally reserves said first channel, and all other provisional channels are released.

27. The method of claim 23, in which said origination point confirms reservation in the reservation signal of a resource chain for said communication signal before sending said communication signal to said termination point.

28. A method of assigning a resource chain for transmission of a communication signal from an origination point to a termination point, comprising:
defining an origination point, a first node, a second node and a termination point, interconnected by optical fiber channels each constituted by a defined wavelength on an optical fiber, collectively constituting a route to be evaluated for transmission of a communication signal from said origination point to said termination point;
determining first minimum costs of transmitting said communication signal from said origination point to said first node by using a plurality of first channels, and identifying potential first channels corresponding to said first minimum costs;
determining second minimum costs of transmitting said communication signal from said first node to said second node by using a plurality of second channels, and identifying potential second channels corresponding to said second minimum costs;
determining third minimum costs of transmitting said communication signal from said second node to said termination point by using a plurality of third channels, and identifying potential third channels corresponding to said third minimum costs;
combining said first, second and third minimum costs and determining a plurality of cumulative minimum costs of transmitting said communication signal from said origination point to said termination point on a plurality of channels, and identifying a lowest cumulative minimum cost and corresponding selected first, second and third channels; and
transmitting said communication signal from said origination point to said termination point on said selected first, second and third channels.

29. An optical communications network comprising an origination point, a node and a termination point, interconnected by optical fiber channels each constituted by a defined wavelength on an optical fiber, and including a signal regenerator having a defined capacity adapted to regenerate signals passing through said node, in which a channel for transmission of a communication signal from said origination point to said termination point is determined by a method comprising the following steps:
determining first minimum costs of transmitting said communication signal from said origination point to said node by using a plurality of first channels, and identifying potential first channels corresponding to said first minimum costs;
determining second minimum costs of transmitting said communication signal from said node to said termination point by using a plurality of second channels, and identifying potential second channels corresponding to said second minimum costs;
combining said first and second minimum costs and determining a plurality of cumulative minimum costs of transmitting said communication signal from said origination point to said termination point on a plurality of channels, and identifying a lowest cumulative minimum cost and corresponding selected first and second channels; and
directing said origination point to transmit said communication signal to said termination point on said selected first and second channels.

30. The network of claim 29 in which a reservation signal is provided to store and transmit said first minimum costs.

31. The network of claim 29 in which said lowest cumulative minimum cost is identified at said termination point.

32. The network of claim 29 in which said origination point identifies said selected first channel.

33. The network of claim 29 in which said node identifies said selected second channel.

34. The network of claim 29 in which said node identifies said selected first and second channels.

35. The network of claim 29 in which said reservation signal is directed to a central location for identification of said selected first and second channels.

36. The network of claim 29, in which said origination point stores said first minimum costs and potential first channels corresponding to said first minimum costs.

37. The network of claim 29, in which said node stores said second minimum costs and potential second channels corresponding to said second minimum costs.

38. An optical communications network comprising an origination point, a first node, a second node and a termination point, interconnected by optical fiber channels each constituted by a defined wavelength on an optical fiber, and including a signal regenerator having a defined capacity adapted to regenerate signals passing through said nodes, in which a resource chain for transmission of a communication signal from said origination point to said termination point is determined by a method comprising the following steps:
determining first minimum costs of transmitting said communication signal from said origination point to said first node by using a plurality of first channels, and identifying potential first channels corresponding to said first minimum costs;
determining second minimum costs of transmitting said communication signal from said first node to said second node by using a plurality of second channels, and identifying potential second channels corresponding to said second minimum costs;
determining third minimum costs of transmitting said communication signal from said second node to said termination point by using a plurality of third channels, and identifying potential third channels corresponding to said third minimum costs;
combining said first, second and third minimum costs and determining a plurality of cumulative minimum costs of transmitting said communication signal from said origination point to said termination point on a plurality of channels, and identifying a lowest cumulative minimum cost and corresponding selected first, second and third channels; and
transmitting said communication signal from said origination point to said termination point on said selected first, second and third channels.
